(19) United States
(12) Patent Application Publication
(10) Pub. No.: US 2024/0009665 A1
(43) Pub. Date: Jan. 11, 2024

(54) FANOUT FLOW CELL

(71) Applicant: Illumina, Inc., San Diego, CA (US)

(72) Inventors: Ravi BILLA, San Diego, CA (US); John WALKER, San Diego, CA (US); Arvin EMADI, San Diego, CA (US); Jon ADAY, Escondido, CA (US); Tara BOZORG-GRAYELI, San Diego, CA (US); Ludovic VINCENT, San Diego, CA (US); Hai TRAN, San Diego, CA (US); Sanket RATHORE, San Diego, CA (US)

(21) Appl. No.: 18/003,281

(22) PCT Filed: Feb. 1, 2022
(86) PCT No.: PCT/US2022/014740

§ 371 Date: Dec. 23, 2022

Related U.S. Application Data
(60) Provisional application No. 63/146,444, filed on Feb. 5, 2021.
(60) Provisional application No. 63/169,423, filed on Apr. 1, 2021.

(51) Int. Cl. B01L 3/00

(52) U.S. Cl. CPC B01L 3/502715; B01L 3/502707; B01L 2300/0645; B01L 2200/0647; B01L 2300/0887; B01L 2300/0819

(57) ABSTRACT

Provided herein include various examples of a flow cell and methods for forming aspects of flow cell. The method may include applying a first adhesive to a substrate. The method may include orienting a die on the first adhesive. The method may also include orienting a package on the first adhesive. The package includes a die and a top surface of the die comprises an active surface and electrical contact points. Surfaces adjacent to the active surface on at least two opposing sides of the active surface form fanout regions for utilization in a fluidic path of the flow cell. The method further may include applying a second adhesive to a part of the package and attaching a lid to the second adhesive to define a fluidic flow-cell cavity below the lid and above a surface comprising the active surface and the fanout regions.

### CROSS-REFERENCE TO RELATED APPLICATIONS

This PCT International Patent Application claims priority to U.S. Provisional Patent Application No. 63/146,444, filed Feb. 5, 2021, and entitled Fanout Flow Cell and U.S. Provisional Application No. 63/169,423, filed on Apr. 1, 2021, and entitled Fanout Flow Cell, the entire contents of which are hereby incorporated herein by reference.

### BACKGROUND

Various protocols in biological or chemical research involve performing controlled reactions. The designated reactions can then be observed or detected and subsequent analysis can help identify or reveal properties of chemicals involved in the reaction. In some multiplex assays, an unknown analyte having an identifiable label (e.g., fluorescent label) can be exposed to thousands of known probes under controlled conditions. Each known probe can be deposited into a corresponding well of a microplate. Observing any chemical reactions that occur between the known probes and the unknown analyte within the wells can help identify or reveal properties of the analyte. Other examples of such protocols include known DNA sequencing processes, such as sequencing-by-synthesis (SBS) or cyclic-array sequencing.

In some fluorescent-detection protocols, an optical system is used to direct excitation light onto fluorophores, e.g., fluorescently-labeled analytes and to also detect the fluorescent emissions signal light that can emit from the analytes having attached fluorophores. In other proposed detection systems, the controlled reactions in a flow cell are detected by a solid-state light sensor array (e.g., a complementary metal oxide semiconductor (CMOS) detector). These systems do not involve a large optical assembly to detect the fluorescent emissions. The shape of the fluidic flow channel in a flow cell may determine its utility for various uses, for example, SBS or cyclic-array sequencing is enabled in a sensor system utilizing multiple liquid flows, and thus, a fluidic flow channel of specific shape is utilized for SBS or cyclic-array sequencing.

In order to enable SBS in the above-described optical systems, electrical contacts are provided to a sensor in the system (e.g., a CMOS utilized as a detector) in certain of the described optical systems. In many such systems, a significant portion of a CMOS is occupied by a fluidic path, minimizing usage of the sensor itself. To increase the size of the fluidic channel in order to increase usage possibilities for the sensor, a region can create around the sensor called a “fan-out” region. The fan-out region is an area that is packaged with a detector that extends a horizontal distance beyond the detector. For example, in examples where a CMOS sensor is utilized as a detector in the flow cell, the fan-out refers to the additional horizontal distance on each side of the horizontal boundaries of the CMOS sensor.

### SUMMARY

Although forming a flow cell with employing a fan-out region may increase usage possibilities for the sensor, as the fan-out regions assist with fluidic aspects of the flow cell, in some situations and examples of flow cells, preparing the surface of the fan-out region to accomplish the fluidic requirements of the cell may be challenging from a manufacturing and fabrication standpoint. For example, in some cases, preparation of a surface for utilization as a fan-out region may involve a grinding procedure that can damage a surface if the material comprising the surface is not sufficiently tolerant of this process. When a ceramic substrate forms the fan-out region, this challenge may sometimes be appreciated. Meeting tolerance requirements may, in some situations, lead to selecting expensive materials, which may increase costs associated with the flow cell. Accordingly, it may be beneficial for a flow cell fabrication to exclude this grinding process.

Thus, shortcomings of the prior art can be overcome and benefits and advantages as described later in this disclosure can be achieved through the provision of a method for forming a flow cell. Various examples of the method are described below, and the method, including and excluding the additional examples enumerated below, in any combination (provided these combinations are not inconsistent), overcome these shortcomings. The method comprises: applying a first adhesive to a substrate, where a top surface of the substrate comprises electrical contacts; orienting a package on the first adhesive, the package comprising a die where a top surface of the die comprises an active surface and electrical contact points and surfaces adjacent to the active surface on at least two opposing sides of the active surface form fanout regions for utilization in a fluidic path of the flow cell; connecting the electrical contacts on the top surface of the substrate to electrical contact points on the die; applying a second adhesive to a part of the package; and attaching a lid to the second adhesive, where the attaching defines a fluidic flow-cell cavity below the lid and above a surface comprising the active surface and the fanout regions.

In some examples, the method includes forming the package, the forming the package comprises: orienting the die on the first adhesive; and forming the fanout regions by orienting one or more support pieces on the first adhesive adjacent to at least two sides of the die, where the fanout regions comprise a portion of a top surface of the support pieces.

In some examples, the one or more support pieces comprise two support pieces and the orienting the one or more support pieces on the first adhesive adjacent to the at least two sides of the die comprise placing two support pieces adjacent to the die on opposing sides of the die.

In some examples, the one or more support pieces comprise one support piece, the one support piece comprises a cutout, and the orienting the one or more support pieces on the first adhesive adjacent to the at least two sides of the die comprise orienting the one support piece such that the die and electrical contacts are within the cutout.

In some examples, the package comprises a cured electronic molded compound (EMC) material molded around portions of the die, where a portion of the EMC material comprises the fanout regions.

In some examples of the method of forming a flow cell, the forming the fanout regions further comprises: dispensing a material to fill gaps between the one or more support pieces and the die.

In some examples of the method of forming a flow cell, the one or more support pieces comprise a material selected from the group consisting of: glass, silicon, and ceramic.

In some examples of the method of forming a flow cell, the package comprises a cured electronic molded compound (EMC) material molded around portions of the die, and a layer deposited on the EMC material surfaces adjacent to the active surface on the at least two opposing sides of the active surface, and the fanout regions comprise portions of the layer. In some examples of the method of forming a flow cell, the method includes: forming the package, comprising: curing the EMC material around portions of the die.

In some examples of the method of forming a flow cell, forming the package further comprises: planarizing the EMC material surfaces adjacent to the active surface.

In some examples of the method of forming a flow cell, the planarizing comprises: depositing the layer on a surface comprising the top surface of the die and the EMC material surfaces adjacent to the active surface; opening the layer on the active surface; and curing the layer.

In some examples of the method of forming a flow cell, the layer comprises a photoresist.

In some examples of the method of forming a flow cell, a technique for opening the layer is selected from the group consisting of: lithography and lithography plus lift-off.

In some examples of the method of forming a flow cell, the package further comprises vias embedded in the EMC material.

In some examples of the method of forming a flow cell, forming the package further comprises: prior to the curing of the EMC material around portions of the die, embedding the vias in the EMC material.

In some examples of the method of forming a flow cell, the vias are comprised of an electrically conductive material.

In some examples of the method of forming a flow cell, the electrically conductive material is selected from the group consisting of: copper, gold, tungsten, and aluminum.

In some examples of the method of forming a flow cell, the vias extend through the EMC material from a surface of the die opposing the active surface in a direction opposing the active surface.

In some examples of the method of forming a flow cell, connecting the electrical contacts on the top surface of the substrate to the electrical contact points on the die, comprises wire-bonding the electrical contacts to the electrical contact points.

In some examples of the method of forming a flow cell, the method includes encasing the wire-bonded connections with an epoxy.

In some examples of the method of forming a flow cell, the method includes curing the first adhesive and the second adhesive.

In some examples of the method of forming a flow cell, the curing is selected from the group consisting of: thermally curing and ultraviolet (UV) curing.

In some examples of the method of forming a flow cell, the substrate is a printed circuit board.

In some examples of the method of forming a flow cell, the substrate comprises a material selected from the group consisting of: a glass-reinforced epoxy laminate material, FR4, and co-fired ceramic sheets.

In some examples of the method of forming a flow cell, the substrate further comprises electrical contacts on a bottom surface of the substrate, where the electrical contacts on a bottom surface of the substrate are electrically coupled to the electrical contacts on the top surface of the substrate by vias formed through the substrate.

In some examples of the method of forming a flow cell, the method includes forming a heating element in the substrate.

In some examples of the method of forming a flow cell, forming the heating element comprises: placing one or more resistors on one or more of the top surface of the substrate and the bottom surface of the substrate; and coupling the one or more resistors, via the vias, to a metal plane in the substrate.

In some examples of the method of forming a flow cell, the heating element comprises a long wound metal trace, and forming the heating element comprises: forming the heating element in the substrate to function as a resistive heater.

In some examples of the method of forming a flow cell, applying the second adhesive further comprises applying the second adhesive to a portion of the die.

In some examples of the method of forming a flow cell, the die is a complementary metal-oxide-semiconductor.

In some examples of the method of forming a flow cell, the lid comprises two apertures and each aperture defines one of an inlet or an outlet fluidic port.

In some examples of the method of forming a flow cell, the active surface of the die comprises nanowells.

Shortcomings of the prior art can be overcome and benefits and advantages as described later in this disclosure can be achieved through the provision of a flow cell. Various examples of the flow cell are described below, and the flow cell, including and excluding the additional examples enumerated below, in any combination (provided these combinations are not inconsistent), overcome these shortcomings. The flow cell includes: a substrate comprising electrical contacts on a top surface, where the electrical contacts on the top surface of the substrate are connected to electrical contact points on a top surface of a die; a first cured adhesive, where the first cured adhesive is joined to a package, the package comprising: the die, where the top surface of the die further comprises an active surface; and fanout regions comprising surfaces adjacent at least two opposing sides of the active surface, the fanout regions at least partially defining a fluidic path of the flow cell; a second cured adhesive, where the second cured adhesive joins a portion of a top surface of the package to a lid defining a fluidic flow-cell cavity below the lid and above a surface comprising the active surface and the fanout regions; and the lid.

In some examples of the flow cell, the package further comprises: one or more support pieces adjacent to the at least two opposing sides of the active surface of the die, where the one or more support pieces comprise the fanout regions.

In some examples of the flow cell, the one or more support pieces comprise two support pieces oriented on the at least two opposing sides of the active surface of the die.

In some examples of the flow cell, the one or more support pieces comprise one support piece, the one support piece comprises a cutout, and the die and the electrical contacts on the top surface of the substrate are oriented within the cutout.

In some examples of the flow cell, the package further comprises: a cured electronic molded compound (EMC) material molded around portions of the die; a portion of the EMC material forming EMC material surfaces adjacent to the active surface on the at least two opposing sides of the active surface; and a portion of the EMC material surfaces comprise the fanout regions.

In some examples of the flow cell, the package comprises: a cured electronic molded compound (EMC) material molded around portions of the die; a layer deposited on the EMC material surfaces adjacent to the active surface on the at least two opposing sides of the active surface, where the fanout regions comprise portions of the layer.

In some examples of the flow cell, the package further comprises vias embedded in the EMC material.

In some examples of the flow cell, the one or more support pieces comprise a material selected from the group consisting of: glass, silicon, and ceramic.

In some examples of the flow cell, the substrate further comprises electrical contacts on a bottom surface of the substrate and the electrical contacts on a bottom surface of the substrate are electrically coupled to the electrical contacts on the top surface of the substrate by vias formed through the substrate.

In some examples of the flow cell, the substrate further comprises a heating element.

In some examples of the flow cell, the heating element comprises: one or more resistors on one or more of the top surface of the substrate and the bottom surface of the substrate; a metal plane in the substrate; and vias through the substrate coupling the one or more resistors to the metal plane in the substrate.

In some examples of the flow cell, the heating element comprises: a long wound metal trace in the substrate to function as a resistive heater.

In some examples of the flow cell, the lid comprises two apertures and each aperture defines one of an inlet or an outlet fluidic port.

In some examples of the flow cell, the top surface of the die comprises nanowells.

In some examples of the flow cell, the substrate is a printed circuit board.

In some examples of the flow cell, the substrate comprises a material selected from the group consisting of: a glass-reinforced epoxy laminate material, FR4, and co-fired ceramic sheets.

In some examples of the flow cell, the die is a complementary metal-oxide-semiconductor.

In some examples of the flow cell, the substrate further comprises electrical contacts on a bottom surface of the substrate, where the electrical contacts on a bottom surface of the substrate are electrically coupled to the electrical contacts on the top surface of the substrate by vias formed through the substrate.

Shortcomings of the prior art can be overcome and benefits and advantages as described later in this disclosure can be achieved through the provision of a method for forming a flow cell. Various examples of the method are described below, and the method, including and excluding the additional examples enumerated below, in any combination (provided these combinations are not inconsistent), overcome these shortcomings. The method comprises: applying a first adhesive to a substrate, where a top surface of the substrate comprises electrical contacts; orienting a die on the first adhesive, where a top surface of the die comprises an active surface and electrical contact points; forming fanout regions for utilization in a fluidic path of the flow cell, where the forming the fanout regions comprises orienting one or more support pieces on the first adhesive adjacent to at least two sides of the die, where a portion of a top surface of the support pieces on the at least two sides of the die comprise the fanout regions: connecting the electrical contacts on the top surface of the substrate to electrical contact points on the die; applying a second adhesive to a portion of the one or more support pieces; and attaching a lid to the second adhesive, where the attaching defines a fluidic flow-cell cavity below the lid and above a surface comprising the active surface and the fanout regions.

In some examples, the one or more support pieces comprise two support pieces, and orienting the one or more support pieces on the first adhesive adjacent to the at least two sides of the die comprises placing two support pieces adjacent on opposing sides of the die.

In some examples, the one or more support pieces comprise one support piece, where the one support piece comprises a cutout, and orienting the one or more support pieces on the first adhesive adjacent to the at least two sides of the die comprises orienting the one support piece such that the die and electrical contacts are within the cutout.

In some examples, the method also includes securing the wire-bonded connections with an epoxy.

In some examples, forming the heating element comprises: implementing a long wound metal trace in the substrate to function as a resistive heater.

In some examples, the method further comprises utilizing the heating element to heat the substrate.

Shortcomings of the prior art can be overcome and benefits and advantages as described later in this disclosure can be achieved through the provision of a flow cell. Various examples of the flow cell are described below, and the flow cell, including and excluding the additional examples enumerated below, in any combination (provided these combinations are not inconsistent), overcome these shortcomings. The flow cell includes: a substrate comprising electrical contacts on a top surface, where the electrical contacts on the top surface of the substrate are connected to electrical contact points on a top surface of a die; a first cured adhesive, where the first cured adhesive joins the die and one or more support pieces adjacent to at least two sides of the die, to the substrate, where a portion of the top surface of the die and a portion of a top surface of the one or more support pieces, form a surface that is utilized in a fluidic path of the flow cell; a second cured adhesive, where the second cured adhesive joins areas of the one or more support pieces and areas of the top surface of the die proximate to the surface that is utilized in the fluidic path of the flow cell, to a lid; and the lid, where the lid defines a fluidic flow-cell cavity above the surface that is utilized in the fluidic path of the flow cell and below the lid.

In some examples of the flow cell, the one or more support pieces comprise two support pieces oriented on opposing sides of the die.

In some examples of the flow cell, the substrate further comprises electrical contacts on a bottom surface of the substrate, and the electrical contacts on a bottom surface of the substrate are electrically coupled to the electrical contacts on the top surface of the substrate by vias formed through the substrate.

Shortcomings of the prior art can be overcome and benefits and advantages as described later in this disclosure can be achieved through the provision of a method for forming a flow cell. Various examples of the method are described below, and the method, including and excluding the additional examples enumerated below, in any combination (provided these combinations are not inconsistent), overcome these shortcomings. The method comprises: applying a first adhesive to a substrate, where a top surface of the substrate comprises electrical contacts; orienting a die on the first adhesive, where a top surface of the die comprises an active surface and electrical contact points; forming fanout regions for utilization in a fluidic path of the flow cell, where the forming of the fanout regions comprises: orienting two support pieces on the first adhesive on opposing sides of the die, each of the two support pieces adjacent to the die, where the top surface of the die and top surfaces of the two support pieces form an upper surface; and dispensing a material to fill gaps between the two support pieces and the die; connecting the electrical contacts on the top surface of the substrate to electrical contact points on the die; applying a second adhesive to a portion of the one or more support pieces and a portion of the die; and attaching a lid to the second adhesive, where the attaching defines a fluidic flow-cell cavity below the lid and above the upper surface.

Shortcomings of the prior art can be overcome and benefits and advantages as described later in this disclosure can be achieved through the provision of a method for forming a flow cell. Various examples of the method are described below, and the method, including and excluding the additional examples enumerated below, in any combination (provided these combinations are not inconsistent), overcome these shortcomings. The method comprises: applying a first adhesive to a substrate, where a top surface of the substrate comprises electrical contacts; orienting a die on the first adhesive, where a top surface of the die comprises an active surface and electrical contact points; forming fanout regions for utilization in a fluidic path of the flow cell, where the forming the fanout regions comprises: orienting a support piece on the first adhesive, where the support piece comprises a cutout, and where the orienting comprises placing the support piece on the first adhesive such that the die and electrical contacts are positioned within the cutout, where the fanout regions comprise portions of a top surface of the support piece on opposing sides of the die, and where the portions of the top surface and the active surface form an upper surface; connecting the electrical contacts on the top surface of the substrate to electrical contact points on the die with bond wires; and dispensing a second adhesive into the cutout such that the second adhesive fills spaces in the cutout between the die and the support piece and encapsulates the bond wires; applying a third adhesive to a portion of the support piece and a portion of the die; and attaching a lid to the third adhesive, where the attaching defines a fluidic flow-cell cavity below the lid and above the upper surface.

Shortcomings of the prior art can be overcome and benefits and advantages as described later in this disclosure can be achieved through the provision of a method for forming a flow cell. Various examples of the method are described below, and the method, including and excluding the additional examples enumerated below, in any combination (provided these combinations are not inconsistent), overcome these shortcomings. The method comprises: applying a first adhesive to a substrate, where a top surface of the substrate comprises electrical contacts; orienting a package comprising a cured electronic molded compound (EMC) material molded around portions of a die, where a top surface of the die comprises an active surface and electrical contact points, and a portion of the EMC material forms EMC material surfaces adjacent to the active surface on at least two opposing sides of the active surface; connecting the electrical contacts on the top surface of the substrate to electrical contact points on the die; applying a second adhesive to a portion of a top surface of the package; and attaching a lid to the second adhesive, where the attaching defines a fluidic flow-cell cavity below the lid and above a surface comprising the active surface and fanout regions for utilization in a fluidic path of the flow cell, the fanout regions comprising another portion of the top surface of the package.

In some examples, the fanout regions are comprised of the EMC material surfaces adjacent to the active surface on the at least two opposing sides of the active surface.

In some examples, the package further comprises a layer deposited on the EMC material surfaces adjacent to the active surface on the at least two opposing sides of the active surface, and the fanout regions comprise portions of the layer deposited on the EMC material surfaces adjacent to the active surface on the at least two opposing sides of the active surface.

In some examples, connecting the electrical contacts on the top surface of the substrate to the electrical contact points on the die comprises wire-bonding the electrical contacts to the electrical contact points.

In some examples, the method includes securing the wire-bonded connections with an epoxy.

In some examples, the substrate further comprises electrical contacts on a bottom surface of the substrate, and the electrical contacts on a bottom surface of the substrate are electrically coupled to the electrical contacts on the top surface of the substrate by vias formed through the substrate.

In some examples, the method includes forming the package, where forming the package comprises: curing the EMC material around portions of the die.

Shortcomings of the prior art can be overcome and benefits and advantages as described later in this disclosure can be achieved through the provision of a flow cell. Various examples of the flow cell are described below, and the flow cell, including and excluding the additional examples enumerated below, in any combination (provided these combinations are not inconsistent), overcome these shortcomings. The flow cell includes: a substrate comprising electrical contacts on a top surface, where the electrical contacts on the top surface of the substrate are connected to electrical contact points on a top surface of a die; a first cured adhesive, where the first cured adhesive joins a package comprising a cured electronic molded compound (EMC) material molded around portions of a die, where a top surface of the die is exposed and comprises an active surface and the electrical contact points, and a portion of the EMC material forms EMC material surfaces adjacent to the active surface on at least two opposing sides of the active surface, where a portion of the EMC material surfaces comprise fanout regions for utilization in a fluidic path; a second cured adhesive, where the second cured adhesive joins a portion of a top surface of the package to a lid defining a fluidic flow-cell cavity below the lid and above a surface comprising the active surface and the fanout regions; and the lid.

In some examples, the substrate is a printed circuit board, and the die is a complementary metal-oxide-semiconductor.

Shortcomings of the prior art can be overcome and benefits and advantages as described later in this disclosure can be achieved through the provision of a flow cell. Various examples of the flow cell are described below, and the flow cell, including and excluding the additional examples enumerated below, in any combination (provided these combinations are not inconsistent), overcome these shortcomings. The flow cell includes: a substrate comprising electrical contacts on a top surface, where the electrical contacts on the top surface of the substrate are connected to electrical contact points on a top surface of a die; a first cured adhesive, where the first cured adhesive joins a package comprising a cured electronic molded compound (EMC) material molded around portions of the die, where a top surface of the die is exposed and comprises an active surface and the electrical contact points, and a portion of the EMC material forms EMC material surfaces adjacent to the active surface on at least two opposing sides of the active surface, where a layer is planarizing the EMC material surfaces, where a portion of the EMC material surfaces planarized by the layer comprise fanout regions for utilization in a fluidic path; a second cured adhesive, where the second cured adhesive joins a portion of a top surface of the package to a lid defining a fluidic flow-cell cavity below the lid and above a surface comprising the active surface and the fanout regions; and the lid.

Shortcomings of the prior art can be overcome and benefits and advantages as described later in this disclosure can be achieved through the provision of a method for forming an element for possible utilization in one or more flow cells. Various examples of the method are described below, and the method, including and excluding the additional examples enumerated below, in any combination (provided these combinations are not inconsistent), overcome these shortcomings. The method comprises: assembling a package comprising cured molded material surrounding portions of a one or more dies, where one or more pillars of a first electrically conductive material are embedded in the molded material, the assembling comprising: applying a temporary adhesive to a surface of a carrier; orienting the one or more pillars on the adhesive; orienting the one or more dies on the adhesive such that one or more pillars are oriented between each die of the one or more dies, where each one or more pillars is of a greater vertical length than each of the one or more dies; molding the material on the top surface of the carrier and around some surfaces of the one or more dies and the one or more pillars such that a top surface of the mold is of a greater vertical length that the one or more pillars, where the top surface of the mold is parallel to the surface of the carrier; curing the molded material; grinding the top surface of the mold to expose top surfaces of the one or more pillars and top surfaces of the one or more dies to create a new surface; plating the top surfaces of the one or more pillars with a second electrically conductive material to create a seed layer; applying one or more redistribution layers (RDLs), where applying each RDL comprises: patterning the layer above the new surface; opening portions of the layer to form openings; and spreading a third electrically conductive material into each opening such that the third electrically conductive material is spread through the openings and electrically coupled to the seed layer; attaching electrical contacts to a portion of the third electrically conductive material in the openings of an RDL of the one or more RDLs; and removing the carrier and the temporary adhesive to expose a package surface.

In some examples, the method includes: applying surface chemistry to surfaces of the one or more dies exposed by removing the carrier and the temporary adhesive to create active surfaces; and plating surfaces of the one or more pillars exposed by removing the carrier and the temporary adhesive to create electrical contacts on the pillars.

In some examples, the method includes: electrically coupling the electrical contacts on the pillars to portions of the surfaces of the one or more dies comprising the chemistry.

In some examples, a method of electrically coupling the electrical contacts on the pillars to portions of the surfaces of the one or more dies comprising the chemistry is selected from the group consisting of: wire-bonding and printing.

In some examples, the method includes: attaching one or more lids to the package surface, where a fluidic flow-cell cavity is defined below each of the one or more lids and above a surface of each of the corresponding one or more sensors comprising the active surface.

In some examples, the first electrically conductive material and the third electrically conductive material are copper.

In some examples, the second electrically conductive material comprises one or more of nickel and gold.

In some examples, attaching the one or more lids comprises applying an adhesive to a portion of the package surface.

In some examples, opening the portions of the layer to form openings comprises utilizing photolithography.

In some examples, the one or more RDLs comprise three RDLs.

In some examples, orienting the one or more pillars and orienting the one or more dies comprise utilizing a pick and place tool.

In some examples, the molded material comprises electronic molded compound (EMC) material.

Shortcomings of the prior art can be overcome and benefits and advantages as described later in this disclosure can be achieved through the provision of a flow cell. Various examples of the flow cell are described below, and the flow cell, including and excluding the additional examples enumerated below, in any combination (provided these combinations are not inconsistent), overcome these shortcomings. The flow cell includes: a package comprising cured material molded around portions of a die, where one or more pillars of a first electrically conductive material are embedded in the molded material, where a top surface of the package comprises an active surface of the die; and a lid attached to portion of the top surface of the package, where a fluidic flow-cell cavity is defined below the lid and above the active surface.

In some examples, the package includes one or more redistribution layers (RDLs), attached to a bottom surface of the package. The RDLs comprise openings filled with electrically conductive material electrically coupled to the at least one of the one or more pillars.

In some examples, the package includes electrical contacts electrically coupled to the electrically conductive material in the openings of the one or more RDLs.

In some examples, the cured material comprises electronic molded compound (EMC).

Additional features are realized through the techniques described herein. Other examples and aspects are described in detail herein and are considered a part of the claimed aspects. These and other objects, features and advantages of this disclosure will become apparent from the following detailed description of the various aspects of the disclosure taken in conjunction with the accompanying drawings.

It should be appreciated that all combinations of the foregoing aspects and additional concepts discussed in greater detail below (provided such concepts are not mutually inconsistent) are contemplated as being part of the inventive subject matter and to achieve the advantages disclosed herein.

### BRIEF DESCRIPTION OF THE DRAWINGS

One or more aspects are particularly pointed out and distinctly claimed as examples in the claims at the conclusion of the specification. The foregoing and objects, features, and advantages of one or more aspects are apparent from the following detailed description taken in conjunction with the accompanying drawings in which:

FIGS. 1-2 each depict an assembled view and an exploded view of a flow cell with fanout regions, the fanout regions having been formed by utilizing one or more support pieces and assembling the sensor or detector onto the substrate;

FIGS. 3-4 each depict a top view and a bottom view of the flow cells which are depicted in FIGS. 1-2, respectively;

FIG. 5 is a process flow that illustrates a step-by-step formation of the flow cell(s) of FIG. 1 and FIG. 3;

FIG. 6 is a workflow that illustrates a method of forming the flow cell(s) of FIG. 1 and FIG. 3;

FIG. 7 is a process flow that illustrates a step-by-step formation of the flow cell(s) of FIG. 2 and FIG. 4;

FIG. 8 is a workflow that illustrates a method of forming the flow cell(s) of FIG. 2 and FIG. 4;

FIG. 9 depicts a side view of an example of a flow cell, specifically depicting heating elements that can be integrated into the examples discussed herein;

FIGS. 10-11 each depict an assembled view and an exploded view of a flow cell that includes a package that includes material molded around a sensor or detector;

FIGS. 12-13 each depict a side view of one of the packages depicted in FIGS. 10-11;

FIGS. 14-15 each depict a top view and a bottom view of the flow cells which are depicted in FIGS. 10-11, respectively;

FIG. 16 is a process flow that illustrates a step-by-step formation of the flow cell(s) of FIG. 10 and FIG. 14;

FIG. 17 is a workflow that illustrates a method of forming the flow cell(s) of FIG. 10 and FIG. 14;

FIG. 18 is a process flow that illustrates a step-by-step formation of the flow cell(s) of FIG. 11 and FIG. 15;

FIG. 19 is a workflow that illustrates a method of forming the flow cell(s) of FIG. 11 and FIG. 15;

FIG. 20 depicts a side view of an example of a flow cell with elements of the flow cells depicted in FIGS. 10-11 and 14-15, specifically depicting heating elements that can be integrated into the examples discussed herein;

FIGS. 21-31 depict a process flow that illustrates a step-by-step formation of a flow cell that includes the certain aspects of the package depicted in the flow cells of FIGS. 10-11 and 14-15; and

FIG. 32 is a workflow that illustrates a method of forming the flow cell(s) of FIG. 31.

### DETAILED DESCRIPTION

The accompanying figures, in which like reference numerals refer to identical or functionally similar elements throughout the separate views and which are incorporated in and form a part of the specification, further illustrate the present implementation and, together with the detailed description of the implementation, serve to explain the principles of the present implementation. As understood by one of skill in the art, the accompanying figures are provided for ease of understanding and illustrate aspects of certain examples of the present implementation. The implementation is not limited to the examples depicted in the figures.

The terms “connect,” “connected,” “contact” “coupled” and/or the like are broadly defined herein to encompass a variety of divergent arrangements and assembly techniques. These arrangements and techniques include, but are not limited to (1) the direct joining of one component and another component with no intervening components therebetween (i.e., the components are in direct physical contact); and (2) the joining of one component and another component with one or more components therebetween, provided that the one component being “connected to” or “contacting” or “coupled to” the other component is somehow in operative communication (e.g., electrically, fluidly, physically, optically, etc.) with the other component (notwithstanding the presence of one or more additional components therebetween). It is to be understood that some components that are in direct physical contact with one another may or may not be in electrical contact and/or fluid contact with one another. Moreover, two components that are electrically connected, electrically coupled, optically connected, optically coupled, fluidly connected or fluidly coupled may or may not be in direct physical contact, and one or more other components may be positioned therebetween.

The terms “including” and “comprising”, as used herein, mean the same thing.

The terms “substantially”, “approximately”, “about”, “relatively”, or other such similar terms that may be used throughout this disclosure, including the claims, are used to describe and account for small fluctuations, such as due to variations in processing, from a reference or parameter. Such small fluctuations include a zero fluctuation from the reference or parameter as well. For example, they can refer to less than or equal to ±10%, such as less than or equal to ±5%, such as less than or equal to +2%, such as less than or equal to +1%, such as less than or equal to +0.5%, such as less than or equal to +0.2%, such as less than or equal to +0.1%, such as less than or equal to ±0.05%. If used herein, the terms “substantially”, “approximately”, “about”, “relatively,” or other such similar terms may also refer to no fluctuations, that is, +0%.

As used herein, a “flow cell” can include a device having a lid extending over a reaction structure to form a flow channel therebetween that is in communication with a plurality of reaction sites of the reaction structure and can include a detection device that detects designated reactions that occur at or proximate to the reaction sites. A flow cell may include a solid-state light detection or “imaging” device, such as a Charge-Coupled Device (CCD) or Complementary Metal-Oxide Semiconductor (CMOS) (light) detection device. As one specific example, a flow cell can fluidically and electrically couple to a cartridge (having an integrated pump), which can fluidically and/or electrically couple to a bioassay system. A cartridge and/or bioassay system may deliver a reaction solution to reaction sites of a flow cell according to a predetermined protocol (e.g., sequencing-by-synthesis), and perform a plurality of imaging events. For example, a cartridge and/or bioassay system may direct one or more reaction solutions through the flow channel of the flow cell, and thereby along the reaction sites. At least one of the reaction solutions may include four types of nucleotides having the same or different fluorescent labels. In some examples, the nucleotides bind to the reaction sites of the flow cell, such as to corresponding oligonucleotides at the reaction sites. The cartridge and/or bioassay system in these examples then illuminates the reaction sites using an excitation light source (e.g., solid-state light sources, such as light-emitting diodes (LEDs)). In some examples, the excitation light has a predetermined wavelength or wavelengths, including a range of wavelengths. The fluorescent labels excited by the incident excitation light may provide emission signals (e.g., light of a wavelength or wavelengths that differ from the excitation light and, potentially, each other) that may be detected by the light sensors of the flow cell.

Flow cells described herein perform various biological or chemical processes. More specifically, the flow cells described herein may be used in various processes and systems where it is desired to detect an event, property, quality, or characteristic that is indicative of a designated reaction. For example, flow cells described herein may include or be integrated with light detection devices, sensors, including but not limited to, biosensors, and their components, as well as bioassay systems that operate with sensors, including biosensors.

The flow cells facilitate a plurality of designated reactions that may be detected individually or collectively. The flow cells perform numerous cycles in which the plurality of designated reactions occurs in parallel. For example, the flow cells may be used to sequence a dense array of DNA features through iterative cycles of enzymatic manipulation and light or image detection/acquisition. As such, the flow cells may be in fluidic communication with one or more microfluidic channels that deliver reagents or other reaction components in a reaction solution to a reaction site of the flow cells. The reaction sites may be provided or spaced apart in a predetermined manner, such as in a uniform or repeating pattern. Alternatively, the reaction sites may be randomly distributed. Each of the reaction sites may be associated with one or more light guides and one or more light sensors that detect light from the associated reaction site. In one example, light guides include one or more filters for filtering certain wavelengths of light. The light guides may be, for example, an absorption filter (e.g., an organic absorption filter) such that the filter material absorbs a certain wavelength (or range of wavelengths) and allows at least one predetermined wavelength (or range of wavelengths) to pass therethrough. In some flow cells, the reaction sites may be located in reaction recesses or chambers, which may at least partially compartmentalize the designated reactions therein.

As used herein, a “designated reaction” includes a change in at least one of a chemical, electrical, physical, or optical property (or quality) of a chemical or biological substance of interest, such as an analyte-of-interest. In particular flow cells, a designated reaction is a positive binding event, such as incorporation of a fluorescently labeled biomolecule with an analyte-of-interest, for example. More generally, a designated reaction may be a chemical transformation, chemical change, or chemical interaction. A designated reaction may also be a change in electrical properties. In particular flow cells, a designated reaction includes the incorporation of a fluorescently labeled molecule with an analyte. The analyte may be an oligonucleotide and the fluorescently labeled molecule may be a nucleotide. A designated reaction may be detected when an excitation light is directed toward the oligonucleotide having the labeled nucleotide, and the fluorophore emits a detectable fluorescent signal. In another example of flow cells, the detected fluorescence is a result of chemiluminescence or bioluminescence. A designated reaction may also increase fluorescence (or Förster) resonance energy transfer (FRET), for example, by bringing a donor fluorophore in proximity to an acceptor fluorophore, decrease FRET by separating donor and acceptor fluorophores, increase fluorescence by separating a quencher from a fluorophore, or decrease fluorescence by co-locating a quencher and fluorophore.

As used herein, “electrically coupled” and “optically coupled” refers to a transfer of electrical energy and light waves, respectively, between any combination of a power source, an electrode, a conductive portion of a substrate, a droplet, a conductive trace, wire, waveguide, nanostructures, other circuit segment and the like. The terms electrically coupled and optically coupled may be utilized in connection with direct or indirect connections and may pass through various intermediaries, such as a fluid intermediary, an air gap and the like.

As used herein, a “reaction solution,” “reaction component” or “reactant” includes any substance that may be used to obtain at least one designated reaction. For example, potential reaction components include reagents, enzymes, samples, other biomolecules, and buffer solutions, for example. The reaction components may be delivered to a reaction site in the flow cells disclosed herein in a solution and/or immobilized at a reaction site. The reaction components may interact directly or indirectly with another substance, such as an analyte-of-interest immobilized at a reaction site of the flow cell.

As used herein, the term “reaction site” is a localized region where at least one designated reaction may occur. A reaction site may include support surfaces of a reaction structure or substrate where a substance may be immobilized thereon. For example, a reaction site may include a surface of a reaction structure (which may be positioned in a channel of a flow cell) that has a reaction component thereon, such as a colony of nucleic acids thereon. In some flow cells, the nucleic acids in the colony have the same sequence, being for example, clonal copies of a single stranded or double stranded template. However, in some flow cells a reaction site may contain only a single nucleic acid molecule, for example, in a single stranded or double stranded form.

The term “active surface” is used herein to characterize a horizontal surface of a sensor or detector which operates as the sensor or detector within a package. For example, in examples where a CMOS sensor is utilized as a detector in the flow cell, the active surface is a portion of the surface of the CMOS sensor that includes nanowells. Throughout this disclosure, the terms die and wafer are also used in reference to certain examples herein, as a die can include a sensor and the die is fabricated from a wafer.

The term “fan-out” is used herein to characterize an area that is packaged with a detector that extends a horizontal distance beyond the detector. For example, in examples where a CMOS sensor is utilized as a detector in the flow cell, the fan-out refers to the additional horizontal distance on each side of the horizontal boundaries of the CMOS sensor.

As used herein, the term “pillar bump” and the term “bump” are both used to describe electrical contacts in examples illustrated and described herein. Wherever the terms “pillar bump” or “bump” are utilized, a variety of examples of electrical contacts can also be utilized in various examples of apparatuses illustrated herein. The electrical contacts, which may be pillar bumps or bumps, may comprise an electrically conductive material, such as a metal material (e.g., Cu (copper), Au (gold), W (tungsten), Al (aluminum) or a combination thereof), but it is understood that other electrically conductive materials may be utilized.

Reference is made below to the drawings, which are not drawn to scale for ease of understanding, wherein the same reference numbers are used throughout different figures to designate the same or similar components.

In some flow cells, a majority of the active surface of a sensor or detector (e.g., CMOS), is sometimes occupied with fluidics and hence, the active surface, the sensor area, itself, may be underutilized. Flow cells may be formed with fan-out regions in order to move certain of the fluidic functionality away from the active surface such that the full surface of the sensor can be more efficiently and more entirely utilized as a sensor or detector. But certain techniques for forming a fan-out region may increase costs as well as contribute to complexities associated with forming the flow cells. These techniques may also, in certain examples, impose certain limitations on types of materials which can be used to form these fan-out regions. For example, in some flow cells, a grinding process is used on the fan-out regions and to tolerate this process, a costly substrate (or carrier) may be utilized. Examples described herein describe methods for forming flow cells and the resultant flow cells formed by utilizing materials utilized in printed circuit boards (PCBs) as a substrate (e.g., glass, silicon, ceramic, etc.), which are generally understood as being less expensive materials than those utilized in the examples that include the grinding process described above.

The examples described herein do not utilize the aforementioned grinding process, allowing for the variation in material for the substrate. In the examples herein, as illustrated in the figures that follow, the fan-out region is formed by assembling the sensor or detector onto the substrate. In these examples, the fan-out region itself is formed by various methods, including but not limited to: 1) assembling support pieces (e.g., glass, silicon, and ceramic) onto the substrate, a portion of the support pieces forming the fan-out region; and/or 2) packaging a sensor (e.g., CMOS image sensor die) by molding electronic molded compound (EMC) material (an epoxy mold compound) around it, a portion of the EMC material forming the fan-out region. In the latter examples, the EMC molded around the dies may or may not be embedded with vias (e.g., copper vias) for thermal conduction. In these examples, the substrate is a PCB. In some of the examples, the PCB substrates may be embedded with a built-in heating mechanism which, as depicted herein, is accomplished utilizing at least two methods, including but not limited to: 1) implementing a heat spreading plane by placing power resistors on one or more of a top or bottom of a PCB substrate such that heat is carried to a desired location by vias (e.g., conductive vias, metal vias) to a metal plate within the substrate, wherein the (now) heated metal plate spreads the heat in order to maintain a uniform and/or close to uniform temperature distribution at a desired location; and/or 2) implementing resistive paths by utilizing interconnects in the PCB as heat sources by implanting or otherwise implementing (e.g., long-winding) traces in the desired location to generate heat by the resistance of each path. In various examples, the spreader plane and/or the resistive path(s) may be isolated into different zones on the substrate such that the substrate will comprise different temperature zones, which can be adjusted individually.

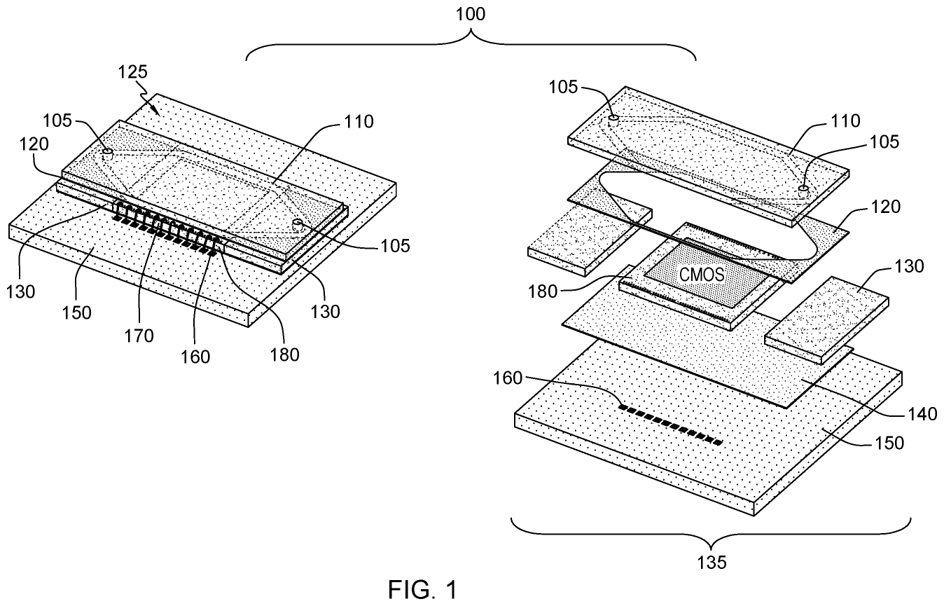

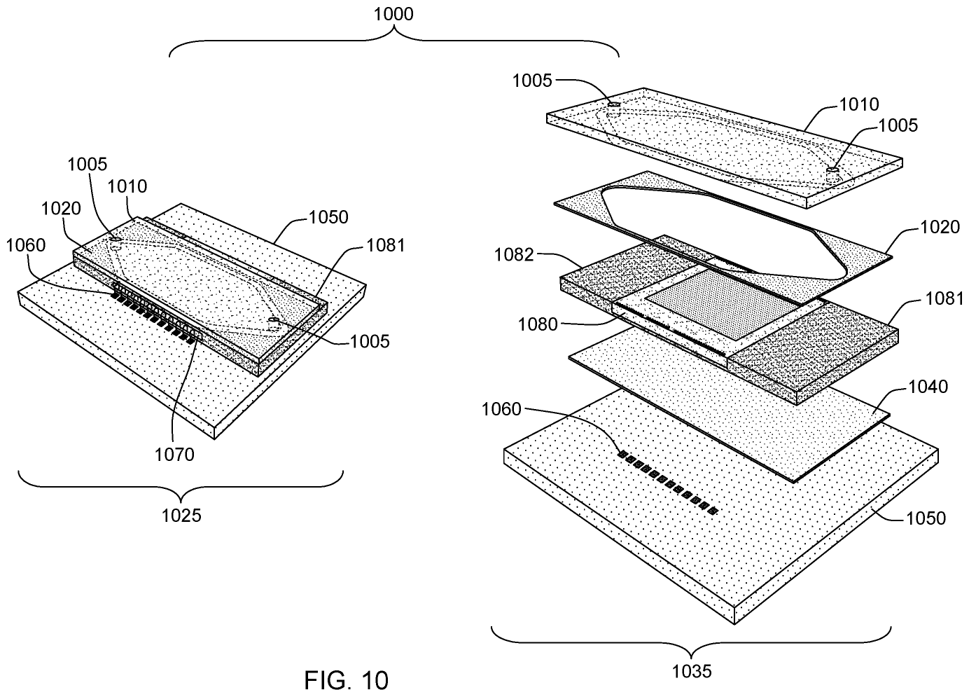

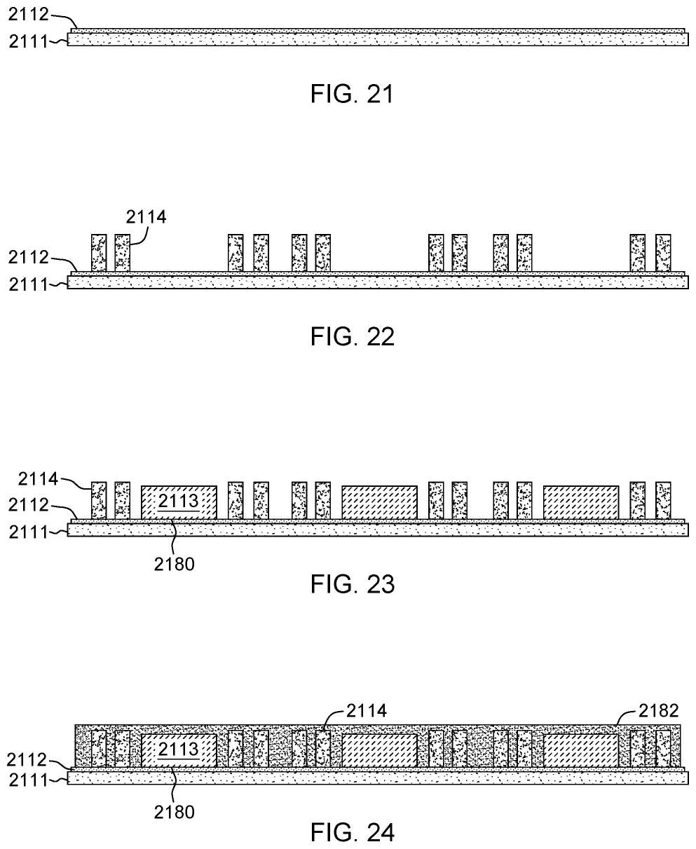

Described herein are various examples of flow cells and methods of forming these flow cells, which utilize support pieces as the fan-out region and various examples of flow cells and methods of forming these flow cells, which utilize EMC material as the fan-out region. FIGS. 1-9 depict various elements and aspects of examples of flow cells which are formed by utilizing support pieces and assembling the sensor or detector onto the PCB, the substrate. FIGS. 10-20 depict various elements and aspects of examples of flow cells which are formed by assembling a package, which includes the sensor or detector and EMC material, onto the PCB, the substrate FIGS. 21-32 depict the formation of some examples of EMC and sensor or detector packages which can be included in the flow cells described, at least in part, in FIGS. 10-20.

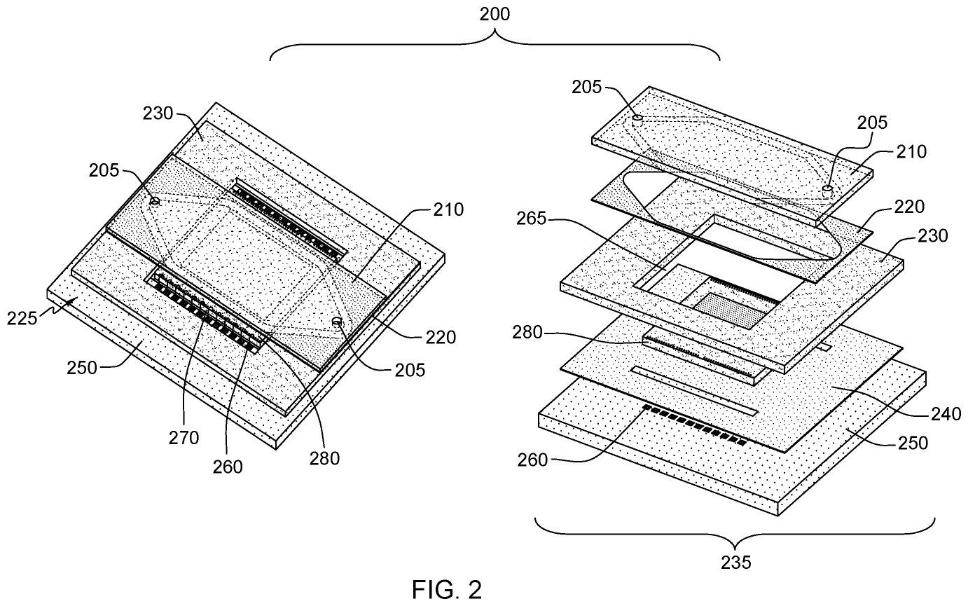

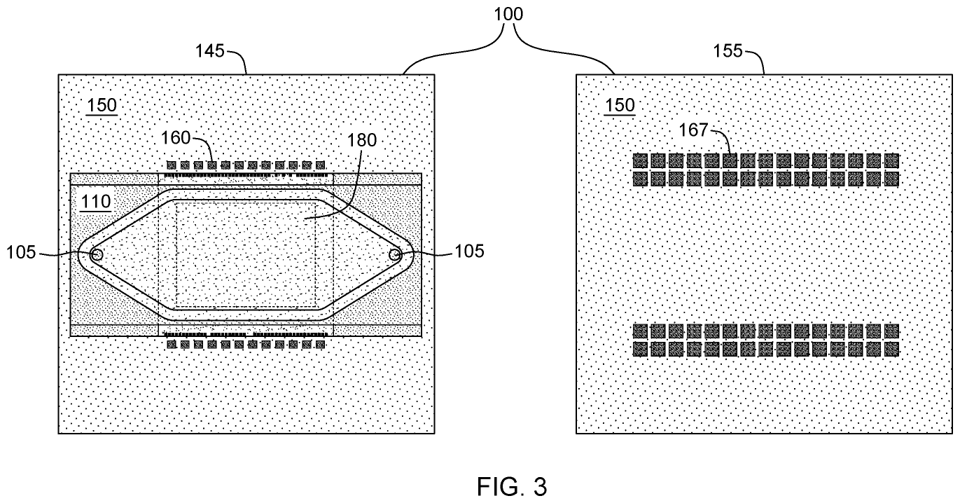

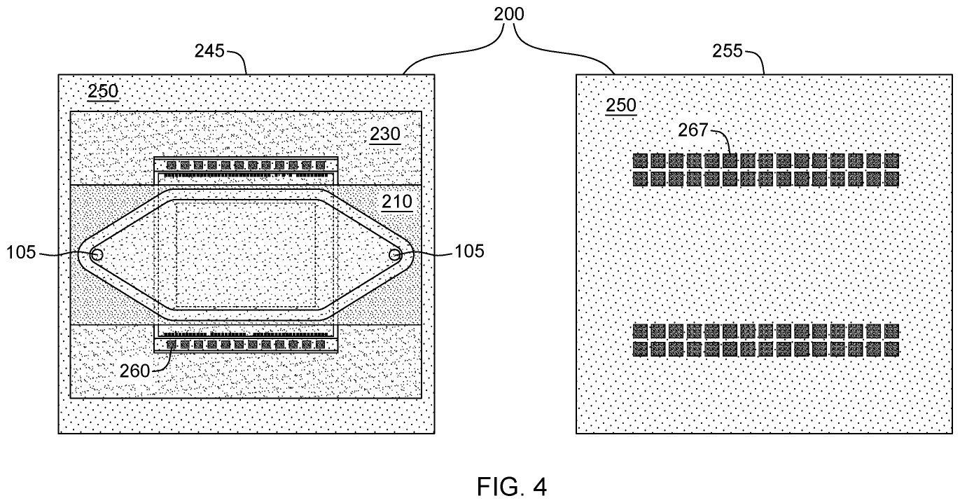

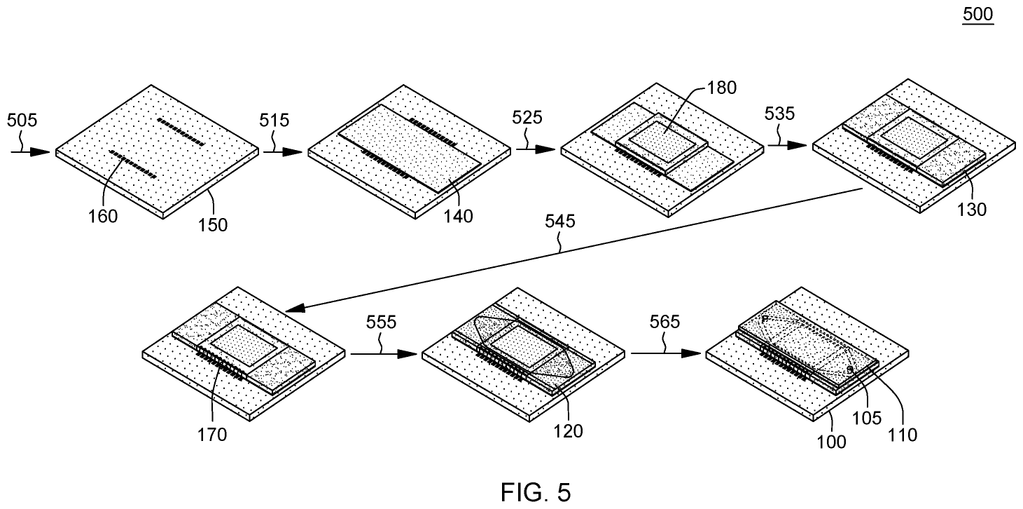

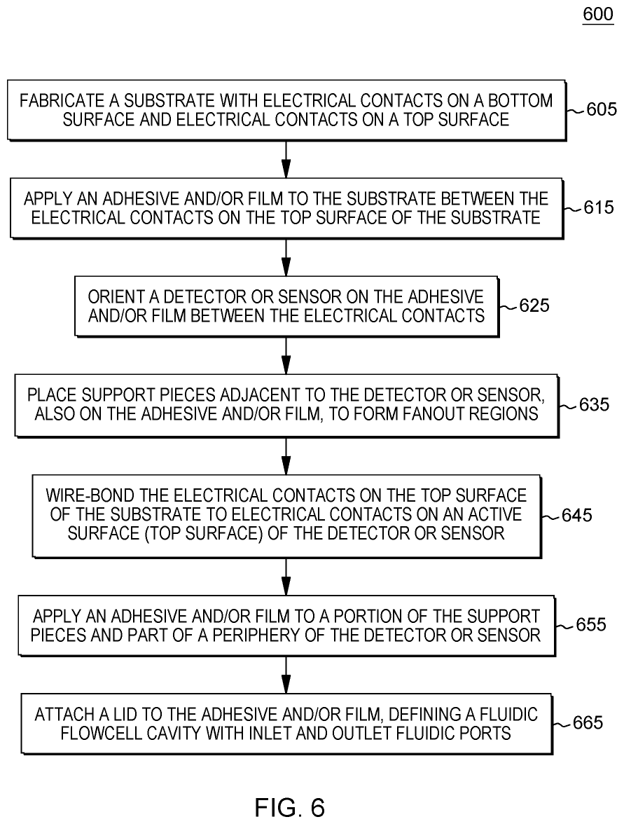

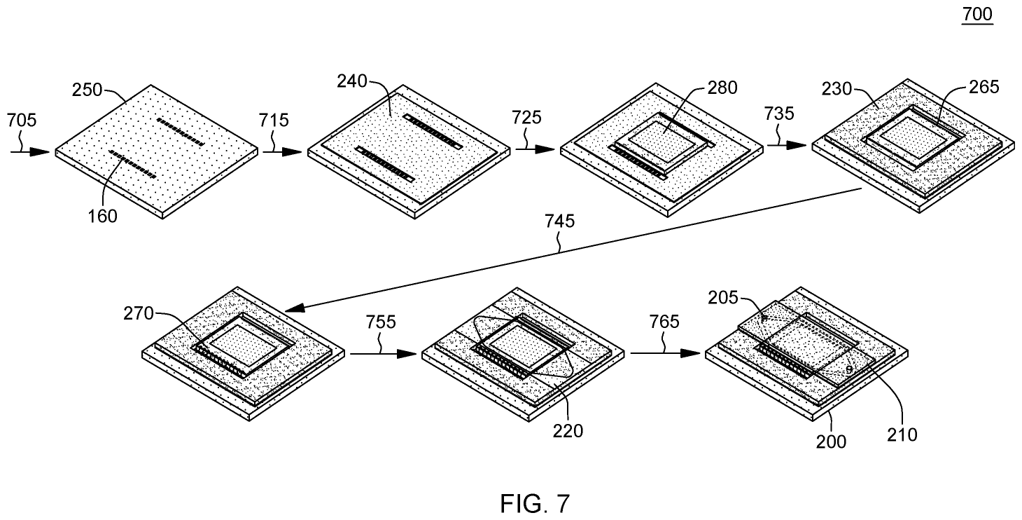

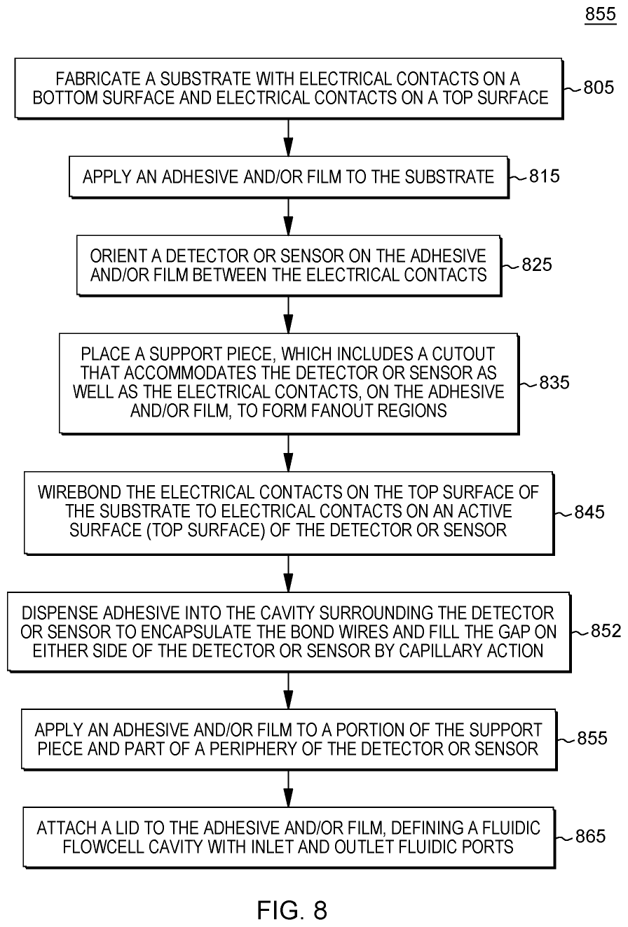

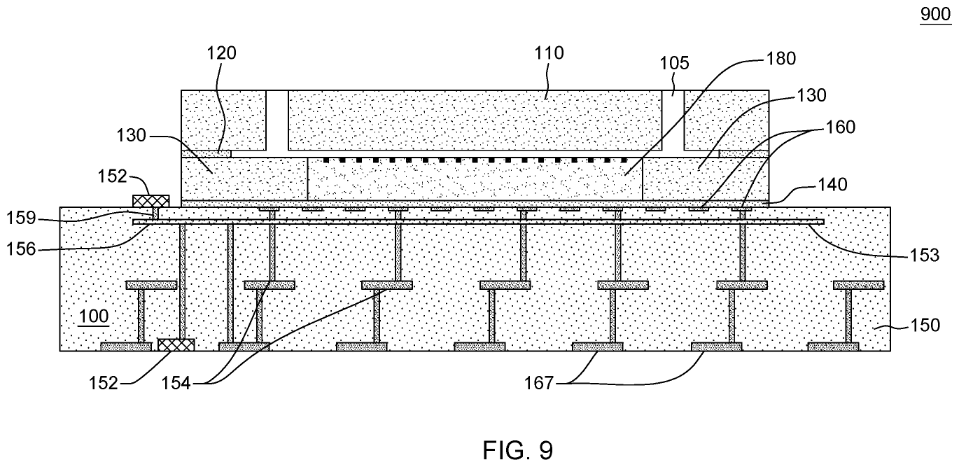

Referring first to the examples that include one or more support pieces, FIGS. 1-2 each include an assembled view and an exploded view of flow cells 100, 200 with fanout regions, which are formed by utilizing support pieces and assembling the sensor or detector onto the PCB, the substrate. FIGS. 3-4 each provide a top view and a bottom view of the flow cells 100, 200 which are depicted in FIGS. 1-2. These figures, FIGS. 1-4, are included to provide an overview of certain elements of a structure of various examples of flow cells 100, 200 which may be formed utilizing methods described herein. FIGS. 5-8 illustrate these methods in greater detail. Specifically, FIG. 5 is a process flow 500 that illustrates a step-by-step formation of the flow cell 100 of FIG. 1 (and FIG. 3). FIG. 6 is a workflow 600 that reiterates various the aspects of FIG. 5, but without the illustrations of the flow cell 100 itself. FIG. 7 is a process flow 700 that illustrates a step-by-step formation of the flow cell 200 of FIG. 2 (and FIG. 4). Like FIG. 6, FIG. 8 is a workflow 800 that reviews aspects in the formation of a flow cell, including flow cell 200 of FIG. 2 (and FIG. 4), without illustrations of these aspect. FIG. 9 provides side views of examples of flow cells, to show heating elements that can be integrated into the examples discussed herein.

Referring first to FIG. 1, included in this figure are two views of a flow cell 100, an assembled view 125, on the left, and an exploded view 135, on the right. As illustrated in this example, the detector or sensor (e.g., CMOS) 180 is attached to a PCB substrate 150. In some examples, the detector or sensor 180 is a CMOS image sensor with patterned nanowell structures on top (e.g., on the active surface). The PCB substrate 150 may be comprised of standard PCB laminate materials, including, but not limited to, a glass-reinforced epoxy laminate material, like FR4 and/or co-fired ceramic sheets. In some examples, the PCB substrate 150, includes a built-in heater (not pictured). As is clearer in the exploded view 135, the detector or sensor (e.g., CMOS) 180 is attached to the PCB substrate 150 using a film or adhesive 140, which likewise attaches support pieces 130 on either side of the detector or sensor (e.g., CMOS) 180, to form a fan-out region. In some examples, this adhesive is dispensed and/or a film is applied that attaches the detector or sensor 180 and the adjacent support pieces 130 to the substrate 150. This film or adhesive 140 may be thermally cured and/or ultraviolet (UV) cured. Materials that these support pieces 130 may be comprised of include, but are not limited to, glass, silicon, and ceramic. Another film or adhesive 120 is used to attach a lid (e.g., glass) 110. This film or adhesive 120 may be dispensed or formed as a film to attach the lid 110 to the detector or sensor 180 (e.g., CMOS die) and to the fan-out support pieces 130. A space below the lid 110 and above the active (top) surface of the detector or sensor (e.g., CMOS) 180 and a top surface of portions of the support pieces 130 (not covered by the film or adhesive 120), forms a flow channel. The lid 110 defines a fluidic flow-cell cavity with inlet and outlet fluidic ports 105. Contacts (not pictured) on the active surface of the detector or sensor (e.g., CMOS) 180 are wire-bonded 170 to electrical connections (e.g., bond pads, contact pads) 160 on the PCB substrate 150. In some examples, the electrical connections 160 are metal bond pads, which are on a top surface of the PCB substrate 150 to enable wire-bonding to bond pads on the top surface of the detector or sensor 180 (e.g., the CMOS die).

As seen in FIG. 2, a difference between the flow cell 100 of FIG. 1 and the flow cell 200 of FIG. 2 is that in FIG. 2, a single support piece 230 is utilized to form fan-out regions on the sides of the detector or sensor (e.g., CMOS) 280. In some examples, the detector or sensor 280 is a CMOS image sensor with patterned nanowell structures on top (e.g., on the active surface). To accommodate the difference in the support structure 230 used to form the fan-out regions, the film or adhesive 240 used to attach the detector or sensor (e.g., CMOS) 280 to a PCB substrate, is shaped differently. As is clearer in the exploded view 235, the detector or sensor (e.g., CMOS) 280 is attached to a PCB substrate 250, which may include a built-in heater (not pictured), using the film or adhesive 240. The PCB substrate 150 may be comprised of standard PCB laminate materials, including but not limited to a glass-reinforced epoxy laminate material, like FR4 and/or co-fired ceramic sheets. The film or adhesive 240 is also used to attach a support piece 230, which surrounds the detector or sensor (e.g., CMOS) 280. The support piece 280 includes a cutout 265, which accommodates the detector or sensor (e.g., CMOS) 280 as well as electrical connections (e.g., bond pads, contact pads) 260 on the PCB substrate 250. The electrical connections (e.g., bond pads, contact pads) 260 are wire-bonded to electrical contacts (not pictured) on the detector or sensor (e.g., CMOS) 280. In some examples, the electrical connections 260 are metal bond pads, which are on a top surface of the PCB substrate 250 to enable wire-bonding to bond pads on the top surface of the detector or sensor 280 (e.g., the CMOS die). The support piece 230 can be comprised of materials that include, but are not limited to, glass, silicon, and ceramic. Another film or adhesive 220 is used to attach a lid (e.g., glass) 210. This film or adhesive 220 may be dispensed or formed as a film to attached lid 210 to the detector or sensor 280 (e.g., CMOS die) and fan-out support piece 230. A space below the lid and above the active (top) surface of the detector or sensor (e.g., CMOS) 280 and a top surface of portions of the support piece 230 (not covered by the film or adhesive 220 or covered by the lid 210), forms a flow channel. The lid 210 also defines a fluidic flow-cell cavity with inlet and outlet fluidic ports 205.

FIG. 3 depicts a top view 145 and a bottom view 155 of the flow cell 100; the flow cell 100 is also depicted in FIG. 1. The bottom view 155 of the flow cell 100, and specifically, of the substrate 150, depicts electrical contacts 167, which can include pads that include pogo pins (referred to as pogo pads). These electrical contacts 167 enable electrical connection of the flow cell 100 (specifically, ultimately, the detector or sensor 180) to a receiving socket and/or instrument. As will be illustrated in later figures, vias and/or various other conductive elements, formed throughout the PCB substrate 150, connect the electrical connections 160 to the electrical contacts 167. As aforementioned the electrical contacts 160 are wire-bonded to bond pads on the top surface of the detector or sensor 180 (e.g., the CMOS die). Visible from the top view 145 in the lid 110 (which is translucent in this example and may be made of glass), are the inlet and outlet fluidic ports 105. Under the lid 110, and not visible from either view in FIG. 4, are the fan-out regions, which are formed, as depicted in FIG. 1, with support pieces 130.

Referring to FIG. 4, FIG. 4 depicts a top view 245 and a bottom view 255 of the flow cell 200; this flow cell 200 is also depicted in FIG. 2. The bottom view 255 of the flow cell 200, and specifically, of the substrate, depicts electrical contacts 267, which can include pads that include pogo pins (referred to as pogo pads). These electrical contacts 267 enable electrical connection of the flow cell 200 (specifically, the detector or sensor 280) to a receiving socket and/or instrument. As will be illustrated in later figures, vias and/or various other conductive elements, formed throughout the PCB substrate 250, connect the electrical connections 260 to the electrical contacts 267. As aforementioned, the electrical contacts 260 are wire-bonded to bond pads on the top surface of the detector or sensor 280 (e.g., the CMOS die). Visible from the top view 245, in the lid 210 (which is translucent in this example and may be made of glass), are the inlet and outlet fluidic ports 205. In contrast to the example in FIGS. 1 and 3, in FIG. 4, because the flow cell 200 utilizes a single support piece 230, with a cutout to accommodate the detector or sensor 280 and the electrical contacts 260, portions of the support piece 230 are not covered by the lid 210, but, rather, extend, in this case, on a longitudinal axis, beyond the bounds of the lid 210. The fan-out regions, formed from a portion of the single support piece 230, are not visible from either view in FIG. 4, as they are under the lid 210.

FIG. 5 illustrates a workflow 500 illustrating exemplary aspects in the formation of some examples of flow cells, including but not limited to, the flow cell 100 depicted in FIGS. 1 and 3. Reference numbers utilized in the workflow 500 which refer to various aspects of the flow cell 100, are provided throughout this process flow 500, for illustrative purposes and not to suggest any limitations. In FIG. 5, a substrate 150 is fabricated with electrical contacts (e.g., FIG. 3, 167) such as pogo pads on the bottom, and electrical contacts 160 (e.g., wire-bond pads) on the top (505). In some examples, the substrate includes a built-in heater assembly (not depicted in FIG. 5). The electrical contacts (e.g., FIG. 3, 167) on the bottom, and electrical contacts 160 on the top are connected to each other through the substrate 150 with connectors, including but not limited to, vias. As aforementioned, the substrate 150 may be made from standard PCB laminate materials, including but not limited to, FR4 and/or co-fired ceramic sheets. An adhesive and/or film 140 is dispensed and/or applied to the substrate 150, between the electrical contacts 160 on the top of the substrate 150 (515). A detector or sensor 180 (e.g., a CMOS die) is oriented on the adhesive and/or film 140, between the electrical contacts 160 (525). The detector or sensor 180 may be oriented, for example, utilizing a pick-and-place machine. At least two support pieces 130 are placed adjacent to the detector or sensor 180, also on the adhesive and/or film 140, to form fanout regions (535). In forming the fanout regions, gaps between each piece of the support pieces 130 and the detector or sensor 180 may be filled, for example, with a liquid dispensed adhesive, and cured (in order to create an even surface for the fluidic functionality of the flow cell 200). The electrical contacts 160 are then wire-bonded to electrical contacts (not depicted) on the detector or sensor 180 (e.g., a CMOS die) (545). For example, wires 170 may be bonded to the electrical contacts 160 (e.g., wire-bond pads) on the substrate 150 and on the detector or sensor 180 (e.g., CMOS die) (these electrical contacts are not pictured) to form electrical connection between them. After the wires are utilized to connect the electrical contacts to each other, the connections may be encased in an epoxy. This epoxy protection for the electrical connections may be added, in some examples, after a lid 110 is secured to the flow cell 100.

Returning to FIG. 5, in this process flow 500, another adhesive and/or film 120 is dispensed or applied to a portion of the support pieces 130 and a portion of periphery of the detector or sensor 180 (e.g., CMOS die) (555). As illustrated in FIG. 5, fan-out regions formed by the support pieces 130 remain adjacent to the detector or sensor 180 (e.g., CMOS die), which are not covered with the adhesive and/or film 120. A lid 110 is attached to this adhesive and/or film 120 (565). A space below the lid 110 and above the active (top) surface of the detector or sensor (e.g., CMOS) 180 and a top surface of portions of the support pieces 130 (not covered by the film or adhesive 120), forms a flow channel. The lid 110 also defines a fluidic flow-cell cavity with inlet and outlet fluidic ports 105; the fluidic ports 105 are inlet and outlet openings in the lid 110.

FIG. 6 is a workflow 600 depicting a process similar to that of FIG. 5. Referring to FIG. 6, a substrate is fabricated with electrical contacts on a bottom surface and electrical contacts on a top surface (these are connected through the substrate using vias or other such connections) (605). An adhesive and/or film is applied to the substrate between the electrical contacts on the top surface of the substrate (615). A detector or sensor (e.g., a CMOS die) is oriented on the adhesive and/or film between the electrical contacts (625). At least two support pieces are placed on the adhesive and/or film, adjacent to the detector or sensor, to form fanout regions (635). In forming the fanout regions, gaps between each piece of the support pieces and the detector or sensor may be filled, for example, with a liquid dispensed adhesive, and cured. The electrical contacts on the top surface of the substrate are wire-bonded to electrical contacts on an active surface (top surface) of the detector or sensor (645). These wire-bonded connections may be protected after they are formed by applying an epoxy. A second adhesive and/or film is applied to a portion of the support pieces and part of a periphery of the detector or sensor (655). A lid is attached to the adhesive and/or film, defining a fluidic flow-cell cavity with inlet and outlet fluidic ports (665). Both the first and second adhesive and/or film are cured at some point after they are applied and utilized to form an attachment.

FIG. 7 illustrates a workflow 700 illustrating exemplary aspects in the formation of some examples of flow cells, including but not limited to, the flow cell 200 depicted in FIGS. 2 and 4. Unlike the flow cell 100 of FIGS. 1 and 3, the flow cell 200 of FIGS. 2 and 4 includes a single support piece 230 to form fanout regions. Reference numbers utilized in the workflow 700 refer to various aspects of the flow cell 200, for illustrative purposes and not to introduce any limitations. In FIG. 5, a substrate 250 is fabricated with electrical contacts (e.g., FIG. 4, 267) such as pogo pads on the bottom, and electrical contacts 260 (e.g., wire-bond pads) on the top (705). In some examples, the substrate includes a built-in heater assembly (not depicted in FIG. 7). The electrical contacts (e.g., FIG. 4, 267) on the bottom, and electrical contacts 260 on the top are connected to each other through the substrate 250 with connectors, including but not limited to, vias. As aforementioned, the substrate 250 may be made from standard PCB laminate materials, including but not limited to, FR4 and/or co-fired ceramic sheets. An adhesive and/or film 240 is dispensed and/or applied to the substrate 250 (715). The adhesive and/or film 240 extends beyond the electrical contacts 260 but is not formed over the electrical contacts 260 (in order to leave the electrical contacts 260 accessible for wire-bonding or otherwise connected to electrical contacts of a sensor or detector 280). A detector or sensor 280 (e.g., a CMOS die) is oriented on the adhesive and/or film 240, between the electrical contacts 260 (725). The detector or sensor 280 may be oriented, for example, utilizing a pick-and-place machine. A single (fanout) support piece 230 is placed on the adhesive and/or film 240, to form fanout regions (735). The support piece 230 has a cutout 265 (which can be implemented using different methods including, but not limited to, laser dicing), so the support piece 230 does not cover a top surface (e.g., active surface) of the detector or sensor 280 or the electrical contacts 260. The electrical contacts 260 are then wire-bonded to electrical contacts (not depicted) on the detector or sensor 280 (e.g., a CMOS die) (745). For example, wires 270 may be bonded to the electrical contacts 260 (e.g., wire-bond pads) on the substrate 250 and on the detector or sensor 280 (e.g., CMOS die) (these electrical contacts are not pictured) to form electrical connection between them. After the wires and utilized to connect the electrical contacts to each other, adhesive (e.g., epoxy) is dispensed into the cavity surrounding the detector or sensor 280 to encapsulate the bond wires and fill the gap on either side of the detector or sensor 280 (e.g., CMOS die) by capillary action and another adhesive and/or film 220 is dispensed or applied to a portion of the support piece 230 and a periphery of the detector or sensor 280 (e.g., CMOS die) (755). A lid 210 is attached to this adhesive and/or film 220 (765). A space below the lid 210 and above the active (top) surface of the detector or sensor (e.g., CMOS) 280 and a top surface of portions of the support piece 230 (not covered by the film or adhesive 120), but covered by the lid 210, forms a flow channel. The lid 210 also defines a fluidic flow-cell cavity with inlet and outlet fluidic ports 205; the fluidic ports 205 are inlet and outlet openings in the lid 210.

FIG. 8 is a workflow 800 depicting a process similar to that of FIG. 7. Referring to FIG. 8, a substrate is fabricated with electrical contacts on a bottom surface and electrical contacts on a top surface (these are connected through the substrate using vias or other such connections) (805). An adhesive and/or film is applied to the substrate (815). A detector or sensor (e.g., a CMOS die) is oriented on the adhesive and/or film between the electrical contacts, which are not covered by the adhesive and/or film (825). A support piece, which includes a cutout that accommodates the detector or sensor as well as the electrical contacts, is placed on the adhesive and/or film, to form fanout regions (835). The electrical contacts are wire-bonded to electrical contacts on the detector or sensor (845). Adhesive (e.g., epoxy) is dispensed into the cavity surrounding the detector or sensor to encapsulate the bond wires and fill the gap on either side of the detector or sensor by capillary action (852). Another adhesive and/or film is dispensed or applied to a portion of the support piece and a periphery of the detector or sensor (855). A lid is attached to the adhesive and/or film, defining a fluidic flow-cell cavity with inlet and outlet fluidic ports (865). Both the first and second adhesive and/or film are cured at some point after they are applied and utilized to form an attachment.

Referring now to FIG. 9, as aforementioned, some examples of flow cells formed utilizing aspects of some of the methods described herein are formed on a substrate that include various heating elements. FIG. 9 depicts a side view 900 flow cell 100 similar to the flow cell 100 of FIGS. 1 and 3, with this detail added to the substrate 150. The consistency in the numbering is provided for illustrative purposes. The flow cell 200 of FIGS. 2 and 4 may share substantially the same elements save a single support piece 230 (see, FIGS. 2 and 4) surrounds the detector or sensor 280 on all four sides. FIG. 9 is not duplicated with reference numbers to a flow cell in FIGS. 2 and 4, but the commonly named elements are relevant in both configurations.

The flow cell 100 of FIG. 9 includes various aspects that are also visible in other figures. For example, the flow cell 100 includes at least two support pieces 160, which are on either side of a detector or sensor 180. The support pieces 106 enable fluidic fan-out in the flow cell 100 and may be comprised of materials, including but not limited to, glass, silicon, and/or ceramic. In this example, the detector or sensor 180 is CMOS image sensor with patterned nanowell structures 177 on top. The support pieces 160 and the detector or sensor 180 are attached to a substrate with an adhesive and/or a film 140. This adhesive and/or a film 140 may be dispensed or applied as a film to make this attachment and may then be cured (e.g., thermally cured or UV cured). The substrate 150 in this example is made from standard PCB laminate materials, including but not limited to, FR4 and/or co-fired ceramic sheets. The substrate includes electrical connections on its top surface 160, and electrical connections on its bottom surface 167. In this example, the electrical connections of the top surface 160 are (e.g., metal) bond pads, which enable wire-bonding to bond-pads on the top surface of the detector or sensor 180 (e.g., the CMOS die). Meanwhile, the electrical connections on its bottom surface 167 are pogo pads, which enable electrical connection to a receiving socket or instrument. Also included in the flow cell 100 are fluidics and a glass lid 110 defines the fluidic flow-cell cavity with inlet and outlet fluidic ports 105. The (e.g., glass) lid 110 is attached to portions of the support pieces 160 and the detector or sensor 180 with an adhesive 120. Like the adhesive and/or a film 140, this adhesive or film 120 may also be dispensed or applied as a film. This adhesive or film 120 may then be cured (e.g., thermally cured or UV cured).

The substrate 150 of FIG. 9 has embedded heaters to control the temperature of the package. As aforementioned, some or all of these elements may also be integrated into the examples of flow cells 200 in FIGS. 2 and 4. In the flow cell 100 of FIG. 9, the heating can be achieved by one or more of two ways. First, power resistors 152 may be placed on the top or bottom of the substrate 150 and heat is transferred to the desired location by vias 159, and a metal plane 153 spreads the heat over the desired area to maintain uniform temperature. Second, a long winding metal trace 156 in this desired location can function as a resistive heater, without separate power resistors. Depicted as structurally similar as are a heat spreading metal plane 153 and a long wound metal trace 156 functioning as a resistive heater. Also, vias 154 are metal interconnect layers in the substrate that enable electrical connection from the detector or sensor 180 to the electrical connections on its bottom surface 167.

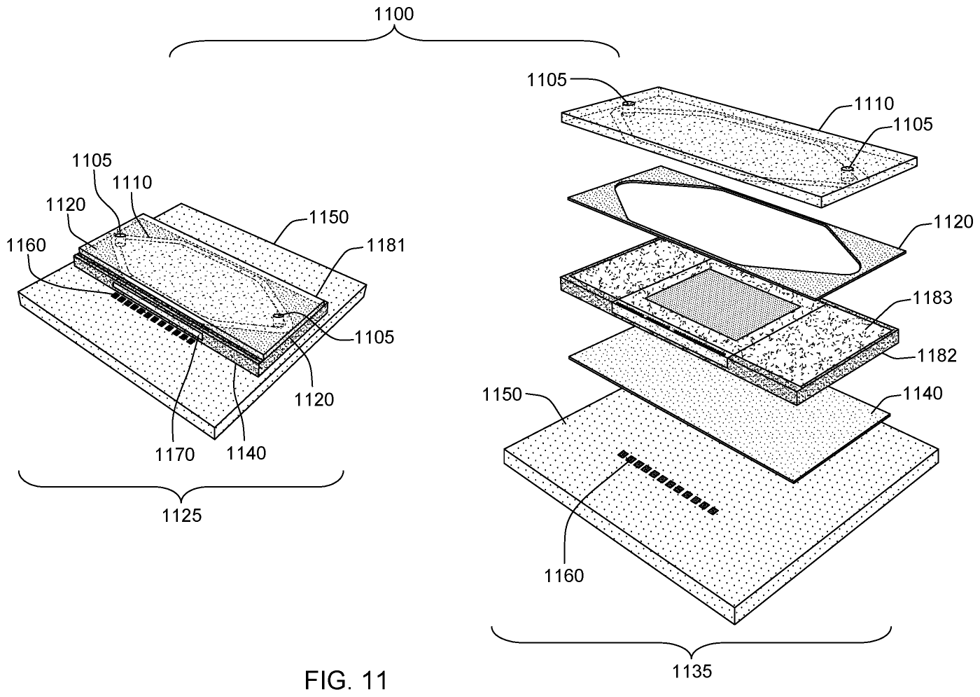

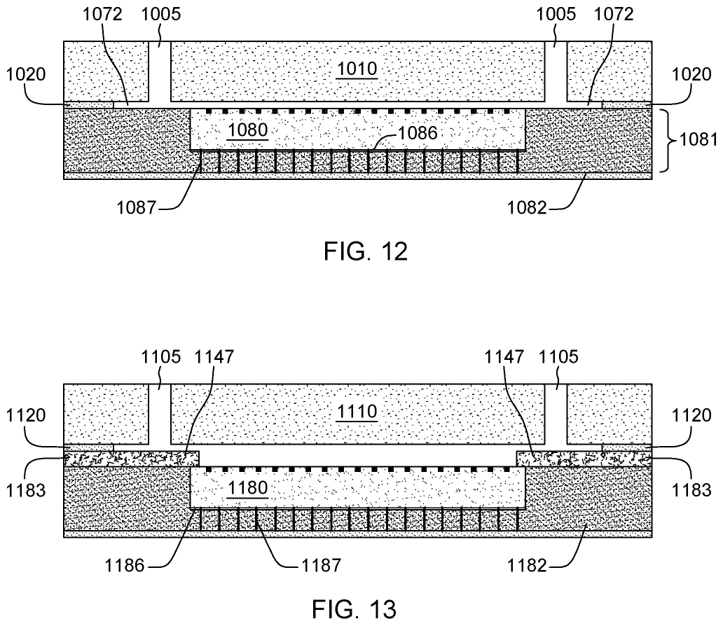

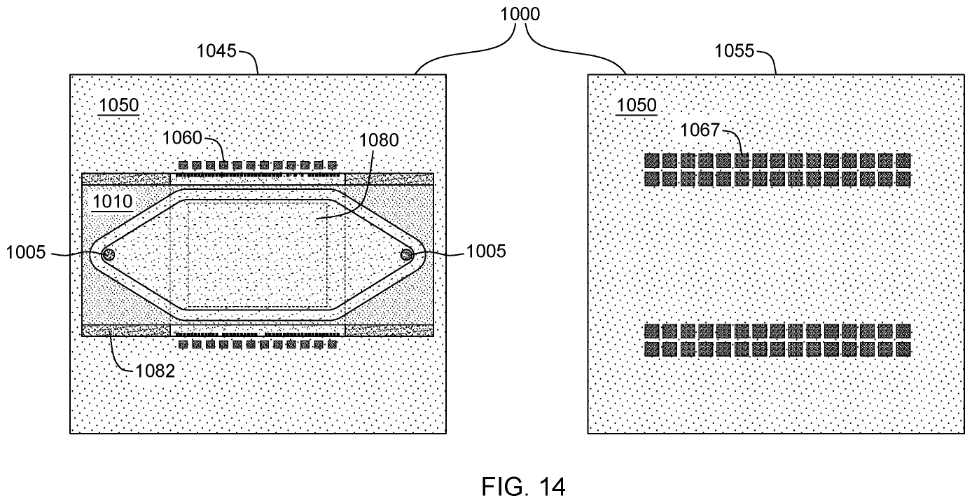

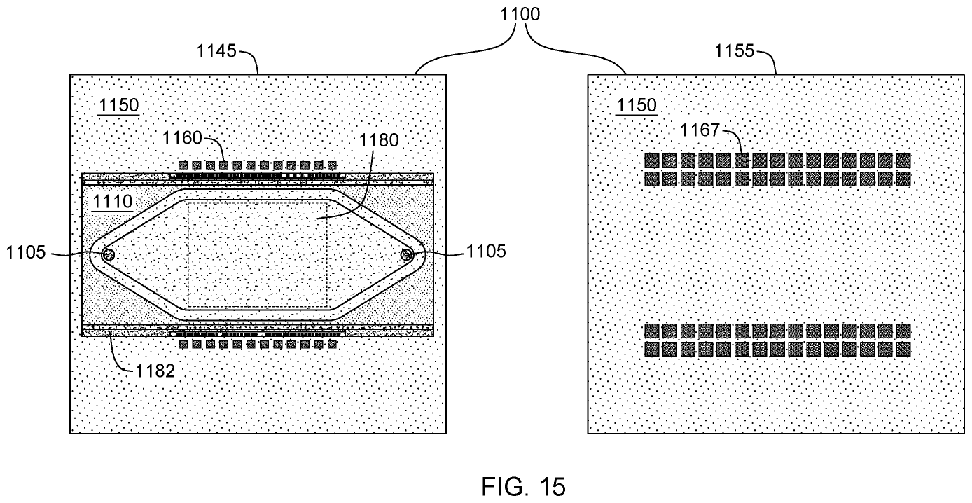

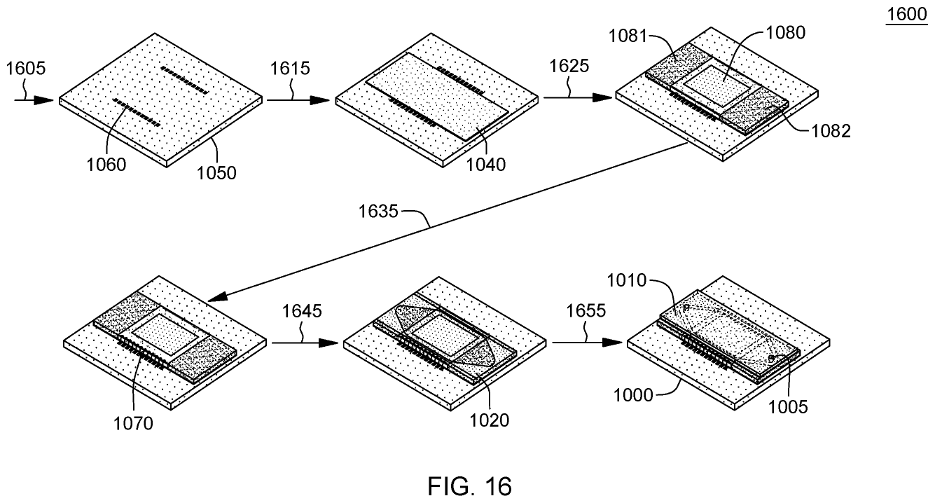

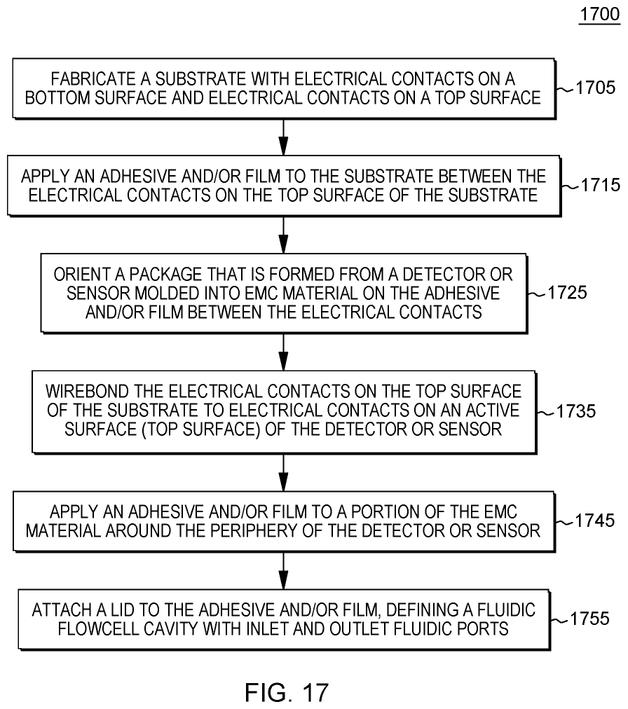

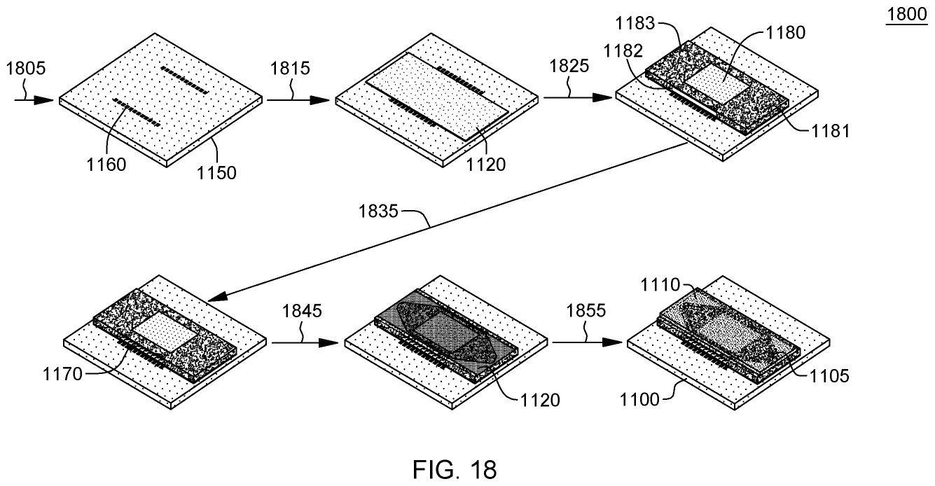

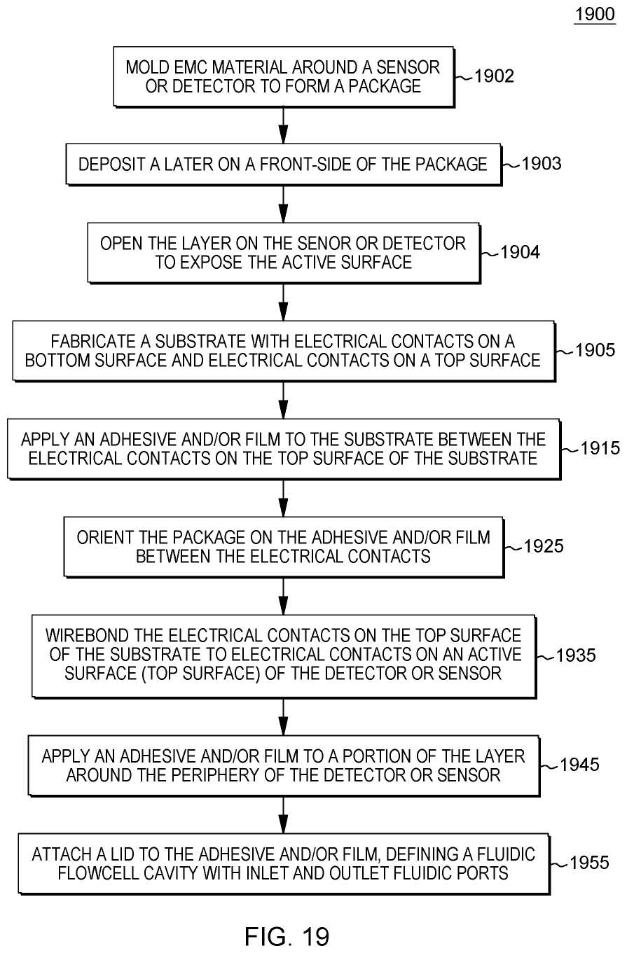

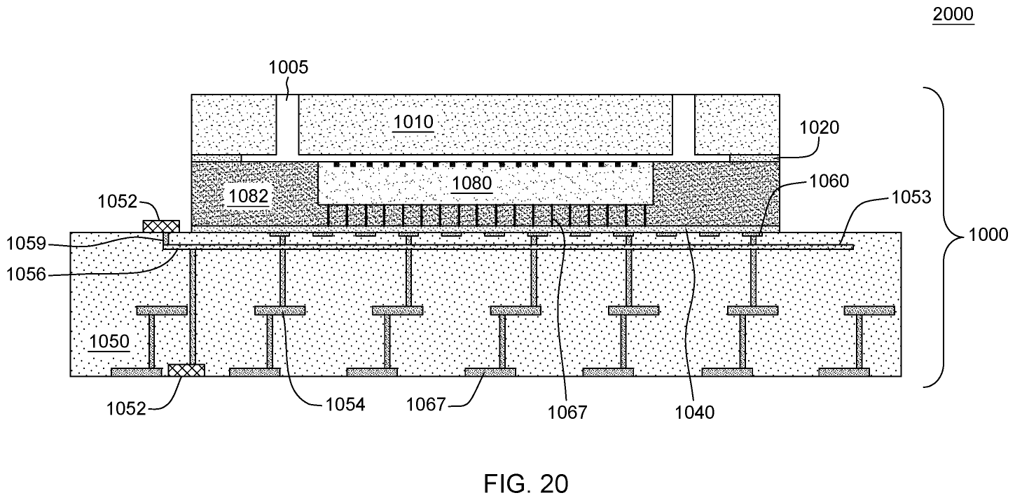

Reference is now made to the examples that include EMC material molded around a sensor or detector, which are depicted, at least in part, in FIGS. 10-20. To that end, FIGS. 10-11 each include an assembled view and an exploded view of flow cells 1000, 1100 with fanout regions, which are formed, for example, by assembling a package that includes EMC material molded around a sensor or detector onto the PCB, the substrate. FIGS. 12-13 depict side views of the packages that include the EMC material and the sensor or detector which are implemented into flow cell 1000 and flow cell 1100, respectively. FIGS. 14-15 each provide a top view and a bottom view of the flow cells 1000, 1100 which are depicted in FIGS. 10-11. FIGS. 10-15 are included to provide an overview of certain elements of a structure of various examples of flow cells 1000, 1100 which may be formed utilizing methods described herein. FIGS. 16-19 illustrate these methods in greater detail. Specifically, FIG. 16 is a process flow 1600 that illustrates a step-by-step formation of the flow cell 1000 of FIG. 10 (and FIG. 14). FIG. 17 is a workflow 1700 that reiterates various the aspects of FIG. 16, but without the illustrations of the flow cell 1000 itself. FIG. 18 is a process flow 1800 that illustrates a step-by-step formation of the flow cell 1100 of FIG. 11 (and FIG. 15). Like FIG. 17, FIG. 19 is a workflow 1900 that reviews aspects in the formation of a flow cell, including flow cell 1100 of FIG. 11 (and FIG. 15), without illustrations of these aspect. FIG. 20 provides side views of examples of flow cells, to show heating elements that can be integrated into the examples discussed herein.

Referring first to FIG. 10, included in this figure are two views of a flow cell 1000, an assembled view 1025, on the left, and an exploded view 1035, on the right. As illustrated in this example, a package 1081 that includes a detector or sensor (e.g., CMOS) 1080, which is molded into an EMC material 1082 is attached to a PCB substrate 1050. In some examples, the detector or sensor 1080 is a CMOS image sensor with patterned nanowell structures on top (e.g., on the active surface). The PCB substrate 1050 may be comprised of standard PCB laminate materials, including, but not limited to, a glass-reinforced epoxy laminate material, like FR4 and/or co-fired ceramic sheets. In some examples, the PCB substrate 1050, includes a built-in heater (not pictured). As is clearer in the exploded view 1035, the package 1081 is attached to the PCB substrate 1050 using a film or adhesive. This attachment may or may not be formed by placing the package 1081 on a film or adhesive 1040 with a pick-and-place tool. In some examples, this adhesive is dispensed and/or a film is applied that attaches the package 1081 to the substrate 1050. This film or adhesive 1040 may be thermally cured and/or ultraviolet (UV) cured. Another film or adhesive 1020 is used to attach a lid (e.g., glass) 1010. This film or adhesive 1020 may be dispensed or formed as a film to attach the lid 1010 to the package 1081. A space below the lid 1010 and above the active (top) surface of the detector or sensor (e.g., CMOS) 1080 and a top surface of portions of the EMC material 1082 molded around the detector or sensor (e.g., CMOS) 1080 (not covered by the film or adhesive 1020), forms a flow channel. The lid 1010 defines a fluidic flow-cell cavity with inlet and outlet fluidic ports 1005. Contacts (not pictured) on the active surface of the detector or sensor (e.g., CMOS) 1080 are wire-bonded 1070 to electrical connections (e.g., bond pads, contact pads) 1060 on the PCB substrate 1050. In some examples, the electrical connections 1060 are metal bond pads, which are on a top surface of the PCB substrate 1050 to enable wire-bonding to bond pads on the top surface of the detector or sensor 1080 (e.g., the CMOS die).

As seen in FIG. 11, and further illustrated in FIGS. 12-13, a difference between the flow cell 1000 of FIG. 10 and the flow cell 1100 of FIG. 11 is that in FIG. 11, molding the EMC material 1182 around the sensor or detector (e.g., CMOS) 1180, a layer 1183 is deposited on a front-side of the sensor or detector 1180 and EMC mold material 1182 to planarize the surface. As will be discussed in more detail later herein, this layer 1183 is opened on the sensor or detector and/or active surface (e.g., utilizing lithography or a lithography plus lift-off process). In some examples, the planarizing surface is a photoresist, including but not limited to, SU8. In some examples, as discussed later herein, the layer is patterned and is then cured (e.g., baked). As illustrated in this example, a package 1181 that includes a detector or sensor (e.g., CMOS) 1180, which is molded into an EMC material 1182 is attached to a PCB substrate 1150. As in the example illustrated in FIG. 10., in some examples, the detector or sensor 1180 is a CMOS image sensor with patterned nanowell structures on top (e.g., on the active surface). The PCB substrate 1150 may be comprised of standard PCB laminate materials, including, but not limited to, a glass-reinforced epoxy laminate material, like FR4 and/or co-fired ceramic sheets. In some examples, the PCB substrate 1150, includes a built-in heater (not pictured). As illustrated also in the exploded view 1135, the package 1181 is attached to the PCB substrate 1150 using a film or adhesive. This attachment may or may not be formed by placing the package 1181 on a film or adhesive 1140 with a pick-and-place tool. In some examples, this adhesive is dispensed and/or a film is applied that attaches the package 1181 to the substrate 1150. This film or adhesive 1140 may be thermally cured and/or ultraviolet (UV) cured. Another film or adhesive 1120 is used to attach a lid (e.g., glass) 1110. In these examples, the glass lid 1110 is attached to portion of the layer 1183. This film or adhesive 1120 may be dispensed or formed as a film to attach the lid 1110 to the layer 1183. A space below the lid 1110 and above the active (top) surface of the detector or sensor (e.g., CMOS) 1180 and a top surface of portions of the layer 1183 patterned on the EMC material 1182, which is molded around the detector or sensor (e.g., CMOS) 1180 (not covered by the film or adhesive 1120), forms a flow channel. The lid 1110 defines a fluidic flow-cell cavity with inlet and outlet fluidic ports 1105. Contacts (not pictured) on the active surface of the detector or sensor (e.g., CMOS) 1180 are wire-bonded 1170 to electrical connections (e.g., bond pads, contact pads) 1160 on the PCB substrate 1150. In some examples, the electrical connections 1160 are metal bond pads, which are on a top surface of the PCB substrate 1150 to enable wire-bonding to bond pads on the top surface of the detector or sensor 1180 (e.g., the CMOS die).

FIG. 12 depicts a side view of the flow cell 1000 illustrated in FIG. 10. A package 1081 that includes EMC material 1082 molded around a sensor or detector 1080 (e.g., a CMOS), is attached to a glass lid 1010 with a film or adhesive 1020. A top surface of the EMC material 1072 which is not covered by the film or adhesive 1020, forms a fan-out region. A space below the lid 1010 and above the active (top) surface of the detector or sensor (e.g., CMOS) 1080 and the top surface of the EMC material 1072, which is molded around the detector or sensor (e.g., CMOS) 1080 (not covered by the film or adhesive 1020), forms a flow channel. The lid 1010 defines a fluidic flow-cell cavity with inlet and outlet fluidic ports 1005. The package 1081 includes vias 1087 of an electrically conductive material, such as a metal material (e.g., Cu (copper), Au (gold), W (tungsten), Al (aluminum) or a combination thereof), but it is understood that other electrically conductive materials may be utilized. The vias 1087 and embedded in the EMC material 1082, at a bottom side 1086 of the sensor or detector 1080. As aforementioned, examples of the flow cell 1000 depicted in, among other figures, FIG. 10, may or may not include these vias 1087. Additionally, as will be illustrated in FIGS. 21-31, these vias 1087, if embedded in the EMC material 1082, may be embedded in various configurations. The configuration in this example is provided for illustrative purposes only and does not suggest any limitations to these configurations.

FIG. 13 depicts a side view of the flow cell 1100 illustrated in FIG. 11. As discussed above, a difference between the flow cells 1000, 1100, is the inclusion, in flow cell 1100, of a layer 1183 deposited on a front-side of the sensor or detector 1180 and EMC mold material to planarize the surface. In FIG. 13, a layer 1183 is deposited on a package 1181 that includes EMC material 1182 molded around a sensor or detector 1180 (e.g., a CMOS). In the example illustrated herein, the layer 1183 is deposited on a front-side of the sensor or detector 1180 and EMC mold material to planarize the surface. As illustrated in FIG. 13, this layer 1183 is opened on the sensor or detector and/or active surface (e.g., utilizing lithography or a lithography plus lift-off process) to expose the active surface. A portion of the layer 1183, once cured or baked, is attached to a glass lid 1010 with a film or adhesive 1120. A top surface of the layer 1183, which is not covered by the film or adhesive 1120, forms a fan-out region. A space below the lid 1110 and above the active (top) surface of the detector or sensor (e.g., CMOS) 1180 and a top surface of the layer 1183, forms a flow channel. The lid 1110 defines a fluidic flow-cell cavity with inlet and outlet fluidic ports 1105. As in FIG. 12, in the example illustrated in FIG. 13, the package 1181 includes vias 1187 of an electrically conductive material, such as a metal material (e.g., Cu (copper), Au (gold), W (tungsten), Al (aluminum) or a combination thereof), but it is understood that other electrically conductive materials may be utilized. The vias 1187 and embedded in the EMC material 1182, at a bottom side 1186 of the sensor or detector 1180. Examples of the flow cell 1100 depicted in, among other figures, FIG. 11, may or may not include these vias 1187. These vias 1187, if embedded in the EMC material 1182, may be embedded in various configurations. The configuration depicted in FIG. 13 is provided for illustrative purposes only and does not suggest any limitation to these configurations.

FIG. 14 depicts a top view 1045 and a bottom view 1055 of the flow cell 1000; the flow cell 1000 is also depicted in FIG. 10 and aspects of the flow cell 1000 are depicted in FIG. 12. Returning to FIG. 14, the bottom view 1055 of the flow cell 1000, and specifically, of the substrate 1050, depicts electrical contacts 1067, which can include pads that include pogo pins (referred to as pogo pads). These electrical contacts 1067 enable electrical connection of the flow cell 1000 (specifically, ultimately, the detector or sensor 1080) to a receiving socket and/or instrument. As will be illustrated in later figures, vias and/or various other conductive elements, formed throughout the PCB substrate 1050, connect the electrical connections 1060 to the electrical contacts 1067. As aforementioned the electrical contacts 1060 are wire-bonded to bond pads on the top surface of the detector or sensor 1080 (e.g., the CMOS die). Visible from the top view 1045 in the lid 1010 (which is translucent in this example and may be made of glass), are the inlet and outlet fluidic ports 1005. Under the lid 1010, and not visible from either view in FIG. 14, are the fan-out regions, which are formed, as depicted in FIG. 10, from a portion of the EMC material 1082 in which the detector or sensor 1080 is molded. Portions of the EMC material 1082 are not covered by the lid 1010, but, rather, extend, in this case, on a longitudinal axis, beyond the bounds of the lid 1010. The fan-out regions, formed from a portion of the EMC material 1082 in which the detector or sensor 1080 is molded, are not visible from either view in FIG. 14, as they are under the lid 1010.

Referring to FIG. 15, FIG. 15 depicts a top view 1145 and a bottom view 1155 of the flow cell 1100; this flow cell 1100 is also depicted in FIG. 11. The bottom view 1155 of the flow cell 1100, and specifically, of the substrate, depicts electrical contacts 1167, which can include pads that include pogo pins (referred to as pogo pads). These electrical contacts 1167 enable electrical connection of the flow cell 1100 (specifically, the detector or sensor 1180) to a receiving socket and/or instrument. As will be illustrated in later figures, vias and/or various other conductive elements, formed throughout the PCB substrate 1150, connect the electrical connections 1160 to the electrical contacts 1167. As aforementioned, the electrical contacts 1160 are wire-bonded to bond pads on the top surface of the detector or sensor 1180 (e.g., the CMOS die). Visible from the top view 1145, in the lid 1110 (which is translucent in this example and may be made of glass), are the inlet and outlet fluidic ports 1105. Portions of the s EMC material 1182 are not covered by the lid 1110, but, rather, extend, in this case, on a longitudinal axis, beyond the bounds of the lid 1110. Portions of the layer 1183 patterned atop portion of the EMC material 1182 also extend on the longitudinal axis, beyond the bounds of the lid 1110. The fan-out regions, formed from a portion of the layer 1183 are not visible from either view in FIG. 15, as they are under the lid 1110.

FIG. 16 illustrates a workflow 1600 illustrating exemplary aspects in the formation of some examples of flow cells, including but not limited to, the flow cell 1000 depicted in FIGS. 10 and 11. Reference numbers utilized in the workflow 1600 which refer to various aspects of the flow cell 1000, are provided throughout this process flow 1600, for illustrative purposes and not to suggest any limitations. In FIG. 16, a substrate 1050 is fabricated with electrical contacts (e.g., FIG. 14, 1067) such as pogo pads on the bottom, and electrical contacts 1060 (e.g., wire-bond pads) on the top (1605). In some examples, the substrate includes a built-in heater assembly (not depicted in FIG. 16). The electrical contacts (e.g., FIG. 14, 1067) on the bottom, and electrical contacts 1060 on the top are connected to each other through the substrate 1050 with connectors, including but not limited to, vias. As aforementioned, the substrate 1050 may be made from standard PCB laminate materials, including but not limited to, FR4 and/or co-fired ceramic sheets. An adhesive and/or film 1040 is dispensed and/or applied to the substrate 1050, between the electrical contacts 1060 on the top of the substrate 1050 (1615). A package 1081 formed from a detector or sensor 1080 (e.g., a CMOS die) molded into an EMC material 1082 is placed on to the adhesive with a pick-and-place tool and is oriented on the adhesive and/or film 1040, between the electrical contacts 1060 (1625). The detector or sensor 1080 may be oriented, for example, utilizing a pick-and-place machine. The electrical contacts 1060 are then wire-bonded to electrical contacts (not depicted) on the detector or sensor 1080 (e.g., a CMOS die) (1635). For example, wires 1070 may be bonded to the electrical contacts 1060 (e.g., wire-bond pads) on the substrate 1050 and on the detector or sensor 1080 (e.g., CMOS die) (these electrical contacts are not pictured) to form electrical connection between them. After the wires are utilized to connect the electrical contacts to each other, the connections may be encased in an epoxy. This epoxy protection for the electrical connections may be added, in some examples, after a lid 1010 is secured to the flow cell 1000.

Returning to FIG. 16, in this process flow 1600, another adhesive and/or film 1020 is dispensed or applied to a portion of the EMC material 1082 around the periphery of the detector or sensor 1080 (e.g., CMOS die) (1645). As illustrated in FIG. 16, a top surface 1072 of the EMC material 1082, which is not covered by the film or adhesive 1020 and is adjacent to the detector or sensor 1080 (e.g., CMOS die), forms a fan-out region. A lid 1010 is attached to this adhesive and/or film 1020 (1655). A space below the lid 1010 and above the active (top) surface of the detector or sensor (e.g., CMOS) 1080 and the top surface 1072 of the EMC material 1082, forms a flow channel. The lid 1010 also defines a fluidic flow-cell cavity with inlet and outlet fluidic ports 1005; the fluidic ports 1005 are inlet and outlet openings in the lid 1010.

FIG. 17 is a workflow 1700 depicting a process similar to that of FIG. 16. Referring to FIG. 17, a substrate is fabricated with electrical contacts on a bottom surface and electrical contacts on a top surface (these are connected through the substrate using vias or other such connections) (1705). An adhesive and/or film is applied to the substrate between the electrical contacts on the top surface of the substrate (1715). A package 1081 formed from a detector or sensor 1080 (e.g., a CMOS die) molded into an EMC material 1082 is oriented on the adhesive and/or film between the electrical contacts (1725). The electrical contacts on the top surface of the substrate are wire-bonded to electrical contacts on an active surface (top surface) of the detector or sensor (1735). These wire-bonded connections may be protected after they are formed by applying an epoxy. A second adhesive and/or film is applied to a portion of the EMC material around the periphery of the detector or sensor (1745). A lid is attached to the adhesive and/or film, defining a fluidic flow-cell cavity with inlet and outlet fluidic ports (1755). Both the first and second adhesive and/or film are cured at some point after they are applied and utilized to form an attachment.

FIG. 18 illustrates a workflow 1800 illustrating exemplary aspects in the formation of some examples of flow cells, including but not limited to, the flow cell 1100 depicted in FIGS. 11 and 13. Unlike the flow cell 1000 of FIGS. 10 and 12, the flow cell 1100 of FIGS. 11, 13, and 15 includes a layer 1183 deposited on a front-side of the sensor or detector 1180 and EMC mold material 1182 to planarize this surface. In examples that include this layer 1183, after the EMC mold material 1182 is molded around the sensor or detector 1180, this layer 1183 is deposited on the front-side of the sensor or detector 1180 (e.g., the front-side CMOS) and mold material, to planarize the surface. The layer 1183 is opened on sensor or detector 1180 active surface utilizing a process including, but not limited to, lithography or a lithography plus lift-off process. A non-limiting example of such a planarizing surface could be a photoresist like SU8. After patterning of the layer 1183, in some examples, the layer 1183 may or may not be cured through baking.

Reference numbers utilized in the workflow 1800 refer to various aspects of the flow cell 1100, for illustrative purposes and not to introduce any limitations. In FIG. 18, a substrate 1150 is fabricated with electrical contacts (e.g., FIG. 15, 1167) such as pogo pads on the bottom, and electrical contacts 1160 (e.g., wire-bond pads) on the top (1805). In some examples, the substrate includes a built-in heater assembly (not depicted in FIG. 18). The electrical contacts (e.g., FIG. 15, 1167) on the bottom, and electrical contacts 1160 on the top are connected to each other through the substrate 1150 with connectors, including but not limited to, vias. As aforementioned, the substrate 1150 may be made from standard PCB laminate materials, including but not limited to, FR4 and/or co-fired ceramic sheets. An adhesive and/or film 1140 (e.g., FIG. 11, 1140) is dispensed and/or applied to the substrate 1150 (1815). The adhesive and/or film 1140 extends beyond the electrical contacts 1160 but is not formed over the electrical contacts 1160 (in order to leave the electrical contacts 1160 accessible for wire-bonding or otherwise connected to electrical contacts of a sensor or detector 1180). A package 1181 which includes a sensor or detector 1180 molded into an EMC material 1182, the package having been planarized on top with a patternable resist (forming a layer 1183), including but not limited to, SU8, is oriented on the adhesive and/or film 1140, between the electrical contacts 1160 (1825). The package 1181, which was planarized (forming the layer 1183) may be oriented, for example, utilizing a pick-and-place machine. The electrical contacts 1160 are then wire-bonded to electrical contacts (not depicted) on the detector or sensor 1180 (e.g., a CMOS die) (1835). For example, wires 1170 may be bonded to the electrical contacts 1160 (e.g., wire-bond pads) on the substrate 1150 and on the detector or sensor 1180 (e.g., CMOS die) (these electrical contacts are not pictured) to form electrical connection between them. After the wires 1170 are utilized to connect the electrical contacts to each other, adhesive (e.g., epoxy) 1120 is dispensed (e.g., in a film) on a portion of the layer, around the periphery of the sensor or detector 1180 (1845). A lid 1110 is attached to this adhesive and/or film 1120 (1865). A space below the lid 1110 and above the active (top) surface of the detector or sensor (e.g., CMOS) 1180 and a top surface of portions of the layer 1183 (not covered by the film or adhesive 1120), but covered by the lid 1110, forms a flow channel. The lid 1110 also defines a fluidic flow-cell cavity with inlet and outlet fluidic ports 1105; the fluidic ports 1105 are inlet and outlet openings in the lid 1110. The adhesive and/or film 1120 is cured.

FIG. 19 is a workflow 1900 depicting a process similar to that of FIG. 18. Referring to FIG. 19, a package that includes a sensor or detector is formed by molding EMC material around a sensor or detector (1902). A layer (e.g., photoresist) is deposited on the front-side of the package (which includes the sensor or detector (e.g., the front-side CMOS) and the mold material), to planarize the surface (1903). The layer is opened on the sensor or detector to expose the active surface (1904). The layer may or may not be opened utilizing a process including, but not limited to, lithography or a lithography plus lift-off process. A non-limiting example of such a planarizing surface could be a photoresist like SU8. After patterning of the layer, in some examples, the layer may or may not be cured through baking. A substrate is fabricated with electrical contacts on a bottom surface and electrical contacts on a top surface (these are connected through the substrate using vias or other such connections) (1905). An adhesive and/or film is applied to the substrate (1915). A package that includes a detector or sensor (e.g., a CMOS die) molded into EMC material, where the package had been planarized with a layer of patternable resist, is oriented on the adhesive and/or film between the electrical contacts, which are not covered by the adhesive and/or film (1925). The electrical contacts are wire-bonded to electrical contacts on the detector or sensor (1935). In some examples, an adhesive (e.g., epoxy) is dispensed into the cavity surrounding the detector or sensor to encapsulate the bond wires. Another adhesive and/or film is dispensed or applied to a portion of the layer around the periphery of the detector or sensor (1945). A lid is attached to the adhesive and/or film, defining a fluidic flow-cell cavity with inlet and outlet fluidic ports (1955). Both the first and second adhesive and/or film are cured at some point after they are applied and utilized to form an attachment.

Referring now to FIG. 20, as aforementioned, some examples of flow cells formed utilizing aspects of some of the methods described herein are formed on a substrate that include various heating elements. Like FIG. 9, FIG. 20 depicts a side view 2000 flow cell 1000 similar to the flow cell 1000 of FIGS. 10 and 12, with this detail added to the substrate 1050. The consistency in the numbering is provided for illustrative purposes. The flow cell 1100 of FIGS. 11 and 13 may share substantially the same elements save a patterned layer (e.g., FIG. 13, 1183) above the EMC material (e.g., FIG. 13, 1182). FIG. 20 is not duplicated with reference numbers to a flow cell in FIGS. 11 and 13, but the commonly named elements are relevant in both configurations.

As also illustrated in FIGS. 12 and 13, in FIG. 20, the EMC material 1082 molded around the sensor or detector 1080 (e.g., CMOS die) which is embedded with vias 1087 of an electrically conductive material, such as a metal material (e.g., Cu (copper), Au (gold), W (tungsten), Al (aluminum) or a combination thereof). Examples of the structure and formation of the EMC material 1082 embedded with the vias 1087, are discussed further with reference to FIGS. 21-32.

Returning to FIG. 20, the flow cell 1000 of FIG. 20 includes various additional aspects that are also visible in other figures. For example, the flow cell 1000 includes a package 1081 that includes EMC material 1082 molded around a sensor or detector 1080 to provide fluidic fan-out to utilize across the active surface of the flow cell 1000. In this example, the detector or sensor 1080 is CMOS image sensor with patterned nanowell structures 1077 on top. The package 1081 is attached to a substrate with an adhesive and/or a film 1040. This adhesive and/or a film 1040 may be dispensed or applied as a film to make this attachment and may or may not then be cured (e.g., thermally cured or UV cured). The substrate 1050 in this example is made from standard PCB laminate materials, including but not limited to, FR4 and/or co-fired ceramic sheets. The substrate includes electrical connections on its top surface 1060, and electrical connections on its bottom surface 1067. In this example, the electrical connections of the top surface 1060 are (e.g., metal) bond pads, which enable wire-bonding to bond-pads on the top surface of the detector or sensor 1080 (e.g., the CMOS die). Meanwhile, the electrical connections on its bottom surface 1067 are pogo pads, which enable electrical connection to a receiving socket or instrument. Also included in the flow cell 1000 are fluidics and a glass lid 1010 defines the fluidic flow-cell cavity with inlet and outlet fluidic ports 1005. The (e.g., glass) lid 1010 is attached to portions of the support pieces 1060 and the detector or sensor 1080 with an adhesive 1020. Like the adhesive and/or a film 1040, this adhesive or film 1020 may also be dispensed or applied as a film and may or may not then be cured (e.g., thermally cured or UV cured).

The substrate 1050 of FIG. 20 has embedded heaters to control the temperature of the package. As aforementioned, some or all of these elements may also be integrated into the examples of flow cells 1100 in FIGS. 11 and 13. In the flow cell 1000 of FIG. 20, the heating can be achieved by one or more of two ways. First, power resistors 1052 may be placed on the top or bottom of the substrate 1050 and heat is transferred to the desired location by vias 1059, and a metal plane 1053 spreads the heat over the desired area to maintain uniform temperature. Second, a long winding metal trace 1056 in this desired location can function as a resistive heater, without separate power resistors. Depicted as structurally similar are a heat spreading metal plane 1053 and a long wound metal trace 1056 functioning as a resistive heater. Also, vias 1054 are metal interconnect layers in the substrate that enable electrical connection from the detector or sensor 1080 to the electrical connections on its bottom surface 1067.

In the examples of flow cells 1000, 1100 of FIGS. 10 and 11, the flow cells 1000, 1100 include a package 1081, 1181, which itself includes EMC material 1082, 1182, molded around a sensor or detector 1080, 1180.

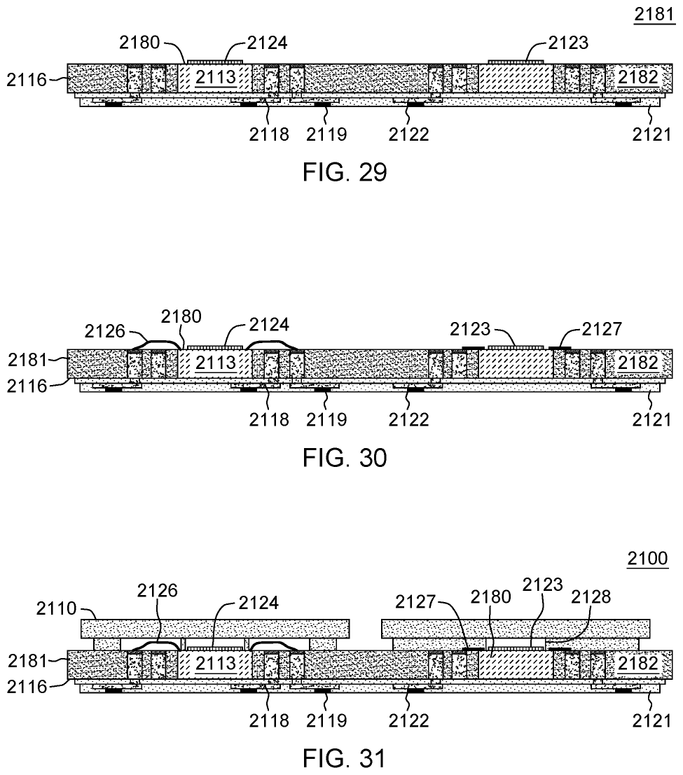

FIGS. 21-32, as aforementioned, depict various examples of a method of forming packages that include cured molded material (e.g., EMC material) surrounding portions of a one or more dies as well as one or more pillars or vias of an electrically conductive material (e.g., 2181, FIG. 29). For the sake of consistency, whenever possible, as with earlier figures, the same designators are used for common and/or similar elements in these figures. In the packages formed, the dies (e.g., sensors or detectors) are at least partially embedded in the molded material, as are the pillars. Hence, these packages include aspects of the packages 1081 and 1181 of flow cells 1000 and 1100. As mentioned earlier, in some flow cell examples discussed here, the packages 1081 and 1181 can be the substantially the same or somewhat similar to the packages depicted in FIGS. 21A-21K. However, unlike earlier figures which focus, among other things, or depicting the formation of a flow cell that may or may not include this type of package, FIG. 21-32 focus on detailing examples related to forming the package itself. While FIGS. 21-31 depict examples of various elements throughout the formation of a flow cell with the package, and examples of the completed flow cell, FIG. 33, for the sake of clarity, reviews portions of some elements of the examples depicted in FIGS. 21-31, but without the illustrations.

Referring first to FIGS. 21-23, in these non-limiting examples, the package is formed on a carrier (e.g., a glass carrier), by utilizing a temporary adhesive 2112 to attach elements such as the pillars 2114 and the die (e.g., sensor or detector) 2113 to the carrier 2111 (e.g., ceramic or glass). Depicted in FIG. 21 are the carrier 2111 and the temporary adhesive 2112 (e.g., a film or adhesive), which is dispensed onto the carrier 2111. The adhesive 2112 is temporary as its removal (which includes the removal of the carrier 2111) is also a part of this example and will be discussed later. For example, the surface of the die 2113 will become the active surface of the sensor or detector 2180 is affixed to the temporary adhesive 2112. The sensor or detector 2180 surface is labeled in FIGS. 23-31, but it may or may not be effective as a sensor or detector 2180 until it is chemically treated, which is discussed and illustrated in FIG. 29. However, referring specifically to FIGS. 22-23, one or more pillars 2114 and one or more dies 2113 are oriented on the temporary adhesive 2112 on top of the carrier 2111. In some examples, these elements may be oriented utilizing a pick and place procedure.

In the examples illustrated by FIGS. 21-31, the orientation of the vias (e.g., the pillars 2114) and the dies 2113 are such that each of the dies 2113 is between two pillars 2114. This orientation is merely provided as an example. The pillars 2113 provide electrical connectivity from each of the sensor or detectors 2180 to any element below the package, including a substrate. This particular orientation demonstrates this advantage but one of skill in the art will appreciate that a variety of different orientations could be utilized to provide similar or the same functionality. As previously illustrated in FIGS. 12 and 13, vias 1087, 1187, may be oriented below a sensor or detector 1080, 1180. Because the vias 1087, 1187, in FIGS. 21-31 demonstrate a particular configuration for electrically conductive elements, which differs from some earlier discussed orientations, these electrically conductive elements are referred to as pillars 2114 for the sake of clarity.

Referring to FIG. 24, a material (e.g., EMC material 2182) is molded onto the carrier 2111 such that the pillars 2114 and the dies 2113 are embedded in the EMC material 2182. As seen in FIG. 24, the EMC material 2182 may or may not cover every surface of the pillars 2114 and the dies 2113 except the surface that is affixed to the temporary adhesive 2112. The EMC material 2182 is cured, which may or may not be accomplished by baking the material. In some examples, including the one depicted in FIG. 24, a top surface formed by the mold exceeds the height of the pillars 2114, which are taller than the dies 2113.

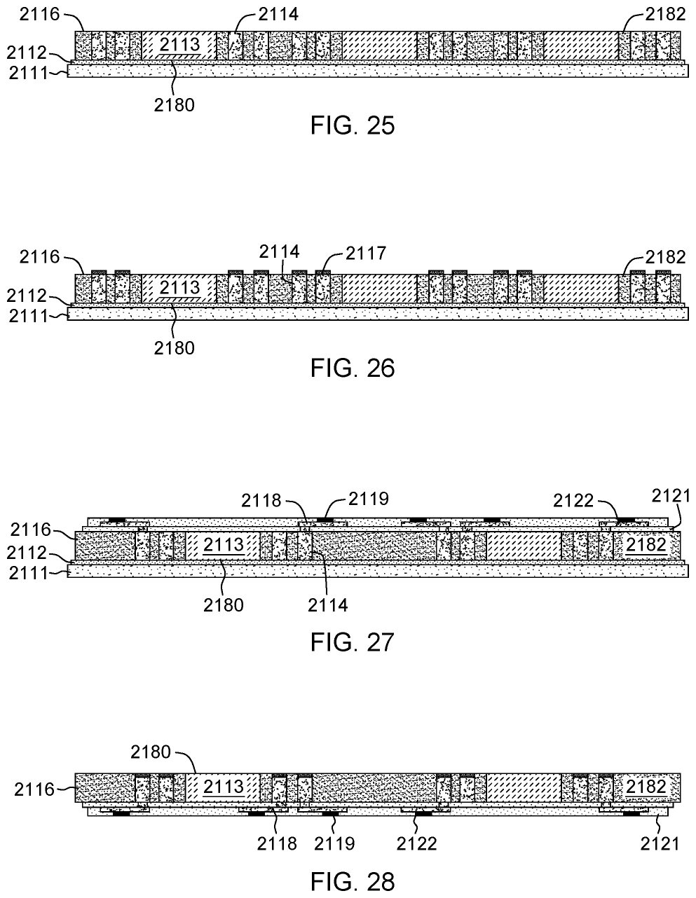

Referring to FIG. 25, as aforementioned, a benefit of certain of the EMC material packages discussed herein is that they include vias (e.g., pillars 2114) that provide electrical connectivity through the whole of the package to a sensor or detector 1080, 1180, 2180, hence, the pillars are made accessible by grinding the EMC material to form a surface 2116 that includes EMC material and surface of the dies 2113 and the pillars 2114. In some examples, these pillars 2114 are copper, which is conducive to the grinding process.

FIG. 26 depicts plating the top surfaces of the pillars 2114 with an electrically conductive material (e.g., nickel or gold) to create a seed layer 2117. As will be discussed herein, in some examples, this seed layer is used to connect the pillars 2114 to additional vias 2118 (e.g., FIG. 27). In some examples, the seed layer is not utilized and redistribution layer (RDL) pads or some other electrical contact serves as a mechanism to enable electrical coupling to the pillars 2114 and ultimately, the sensor or detector 2180. FIGS. 27-31 do not depict the seed layer 2117 as it either was not implemented or, if implemented, not visible.

In FIG. 27 one or more redistribution layers (RDLs) 2121 are applied to the surface 2116. Each RDL applied may or may not be patterned above the surface 2116. In some examples, after each RDL (of the RDLs 2121) is patterned, portions of the RDL are opened to provide accessibility to the electrical elements. One non-limiting example of a process that can be utilized to form the openings 2122 is photolithography. An electrically conductive material 2118 (e.g., copper) is spread through the openings 2122 such that this material is electrically coupled to one or more of the pillars 2114. The material in the openings 2122 forms vias to the pillars 2114. Various non-limiting examples includes one (1) to three (3) RDLs. The openings 2122 in the top RDL are plated (e.g., with gold and/or copper), to form electrical contacts 2119.

Referring to FIGS. 28-29, once the electrical contacts 2119 have been formed, as depicted in FIG. 28, the structure (thus far) is rotated one hundred and eighty (180) degrees and the temporary adhesive 2112 is disengaged so that both the temporary adhesive 2112 and the carrier 2111 may be removed from the structure. FIG. 28 depicts the structure having been rotated and with the temporary adhesive 2112 and the carrier 2111 removed. Removing the temporary adhesive 2112 and the carrier 2111 exposes a surface of the package that includes what will become the active surface 2123 (see, FIG. 29). FIG. 29 depicts an example of at least one package 2181. As illustrated in FIG. 29, chemistry 2124 is applied to a surface of each die 2113, enabling the treated surface of the die to act as a detector or sensor 2180 in certain flow cells. This treated portion of the surface is at least part of the active surface 2123 in some flow cells.

As discussed herein, the pillars 2114 provide connectivity through the package, to the sensor or detector 2180, thus, FIG. 30 depicts two different non-limiting examples of types of connections that can be formed between the electrical contacts 2119 and the sensor or detector 2180. On the left of FIG. 20, an electrical contact 2126 is wire-bonded to the sensor or detector 2180. On the right, printing is utilized to form a printed connection 2127 between the sensor or detector 2180 and an electrical contact 2119. In FIG. 31, a lid 2110 is added over each active surface 2123, defining a fluidic flow channel 2128 above the active surface 2123 and below the lid 2110. In some examples, an adhesive is used to affix the lid 2110 to a top surface of the package 2181.

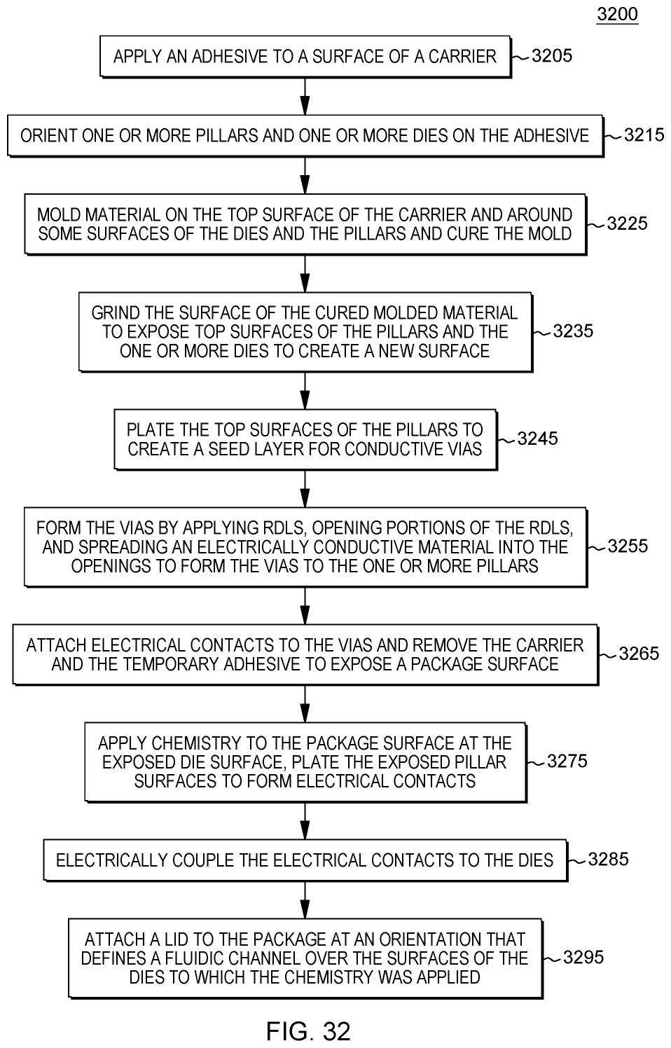

FIG. 32 is a workflow 3200 that reviews aspects in the formation of a flow cells 2100. The workflow 3200 illustrates aspects of assembling a package that includes cured molded material surrounding portions of a one or more dies. In this example, one or more pillars of an electrically conductive material (e.g., copper, gold, etc.) are embedded in the molded material. To assemble the package, an adhesive is applied to a surface of a carrier (e.g., glass, ceramic, etc.) (3205). One or more pillars and one or more dies are oriented on the adhesive (e.g., using pick and place) (3215). In some examples, the pillars are of a greater vertical length than the dies. Material (e.g., EMC material) is molded on the top surface of the carrier and around some surfaces of the one or more dies and the one or more pillars such that a top surface of the mold is of a greater vertical length that the pillars and the mold is cured (3225). The surface of the cured molded material is ground down to expose top surfaces of the one or more pillars and top surfaces of the one or more dies to create a new surface (3235). The top surfaces of the pillars are plated with an electrically conductive material to create a seed layer for conductive vias (3245). To form these vias, one or more redistribution layers are applied and the application includes patterning each layer above the new surface, opening portions of the layer to form openings, and spreading an electrically conductive material into each opening so that the electrically conductive material is spread through the openings, forming the vias to the one or more pillars (3255). Electrical contacts are attached to the vias and the carrier and the temporary adhesive are removed to expose a package surface (3265). Now that the package has been formed, in some examples, chemistry is applied to the package surface at the exposed die surface and the exposed pillar surfaces are plated to form electrical contacts (3275). The electrical contacts are electrically coupled to portions of the surfaces of the one or more dies that were or are treated with the chemistry (3297). A lid is attached to the package at an orientation that defines a fluidic channel over the surfaces of the dies to which the chemistry was or is applied (3299).

Examples described herein include methods for forming flow cells as well as the flow cells themselves. The method may include applying a first adhesive to a substrate, where a top surface of the substrate comprises electrical contacts. The method may include orienting a package on the first adhesive, the package comprising a die where a top surface of the die comprises an active surface and electrical contact points and surfaces adjacent to the active surface on at least two opposing sides of the active surface form fanout regions for utilization in a fluidic path of the flow cell. The method may include connecting the electrical contacts on the top surface of the substrate to electrical contact points on the die. The method may include applying a second adhesive to a part of the package; and attaching a lid to the second adhesive. The attaching defines a fluidic flow-cell cavity below the lid and above a surface comprising the active surface and the fanout regions.

In some examples, the method may include forming the package, the forming the package comprising orienting the die on the first adhesive. The method may also include forming the fanout regions by orienting one or more support pieces on the first adhesive adjacent to at least two sides of the die, where the fanout regions comprise a portion of a top surface of the support pieces.

In some examples, the one or more support pieces comprise two support pieces and the orienting the one or more support pieces on the first adhesive adjacent to the at least two sides of the die comprises placing two support pieces adjacent to the die on opposing sides of the die.

In some examples, the one or more support pieces comprise one support piece, the one support piece comprises a cutout, and the orienting the one or more support pieces on the first adhesive adjacent to the at least two sides of the die comprises orienting the one support piece such that the die and electrical contacts are within the cutout.

In some examples, the package comprises a cured electronic molded compound (EMC) material molded around portions of the die, where a portion of the EMC material comprises the fanout regions.

In some examples of the methods disclosed herein, forming the fanout regions further comprises: dispensing a material to fill gaps between the one or more support pieces and the die.

In some examples of the method of forming a flow cell, the one or more support pieces comprise a material selected from the group consisting of: glass, silicon, and ceramic.

In some examples of the method of forming a flow cell, the package comprises a cured electronic molded compound (EMC) material molded around portions of the die, and a layer deposited on the EMC material surfaces adjacent to the active surface on the at least two opposing sides of the active surface, and the fanout regions comprise portions of the layer.

In some examples of the method of forming a flow cell, the method includes: forming the package, comprising: curing the EMC material around portions of the die.

In some examples of the method of forming a flow cell, forming the package further comprises: planarizing the EMC material surfaces adjacent to the active surface.

In some examples of the method of forming a flow cell, the planarizing comprises: depositing the layer on a surface comprising the top surface of the die and the EMC material surfaces adjacent to the active surface; opening the layer on the active surface; and curing the layer.

In some examples of the method of forming a flow cell, the layer comprises a photoresist.

In some examples of the method of forming a flow cell, a technique for opening the layer is selected from the group consisting of: lithography and lithography plus lift-off.

In some examples of the method of forming a flow cell, forming the package further comprises: prior to the curing of the EMC material around portions of the die, embedding the vias in the EMC material.

In some examples of the method of forming a flow cell, the vias are comprised of an electrically conductive material.

In some examples of the method of forming a flow cell, the electrically conductive material is selected from the group consisting of: copper, gold, tungsten, and aluminum.

In some examples of the method of forming a flow cell, the vias extend through the EMC material from a surface of the die opposing the active surface in a direction opposing the active surface.

In some examples of the method of forming a flow cell, connecting the electrical contacts on the top surface of the substrate to the electrical contact points on the die, comprises wire-bonding the electrical contacts to the electrical contact points.

In some examples of the method of forming a flow cell, the method includes encasing the wire-bonded connections with an epoxy.

In some examples of the method of forming a flow cell, the method includes curing the first adhesive and the second adhesive.

In some examples of the method of forming a flow cell, the curing is selected from the group consisting of: thermally curing and ultraviolet (UV) curing.

In some examples of the method of forming a flow cell, the substrate is a printed circuit board.

In some examples of the method of forming a flow cell, the substrate comprises a material selected from the group consisting of: a glass-reinforced epoxy laminate material, FR4, and co-fired ceramic sheets.

In some examples of the method of forming a flow cell, the substrate further comprises electrical contacts on a bottom surface of the substrate, where the electrical contacts on a bottom surface of the substrate are electrically coupled to the electrical contacts on the top surface of the substrate by vias formed through the substrate.

In some examples of the method of forming a flow cell, the method includes forming a heating element in the substrate.

In some examples of the method of forming a flow cell, forming the heating element comprises: placing one or more resistors on one or more of the top surface of the substrate and the bottom surface of the substrate; and coupling the one or more resistors, via the vias, to a metal plane in the substrate.

In some examples of the method of forming a flow cell, the heating element comprises a long wound metal trace, and forming the heating element comprises: forming the heating element in the substrate to function as a resistive heater.

In some examples of the method of forming a flow cell, applying the second adhesive further comprises applying the second adhesive to a portion of the die.

In some examples of the method of forming a flow cell, the die is a complementary metal-oxide-semiconductor.

In some examples of the method of forming a flow cell, the lid comprises two apertures and each aperture defines one of an inlet or an outlet fluidic port.

In some examples of the method of forming a flow cell, the active surface of the die comprises nanowells.

In some example of the flow cells disclosed herein, the flow cell may include a substrate comprising electrical contacts on a top surface. The electrical contacts on the top surface of the substrate are connected to electrical contact points on a top surface of a die. The flow call may also include a first cured adhesive, where the first cured adhesive is joined to a package. The package may include the die, where the top surface of the die further comprises an active surface and fanout regions comprising surfaces adjacent at least two opposing sides of the active surface, the fanout regions at least partially defining a fluidic path of the flow cell. The flow cell may also include a second cured adhesive, where the second cured adhesive joins a portion of a top surface of the package to a lid defining a fluidic flow-cell cavity below the lid and above a surface comprising the active surface and the fanout regions. The flow cell may also include the lid.

In some examples of the flow cell, the package further comprises: one or more support pieces adjacent to the at least two opposing sides of the active surface of the die, where the one or more support pieces comprise the fanout regions.

In some examples of the flow cell, the one or more support pieces comprise two support pieces oriented on the at least two opposing sides of the active surface of the die.

In some examples of the flow cell, the one or more support pieces comprise one support piece, the one support piece comprises a cutout, and the die and the electrical contacts on the top surface of the substrate are oriented within the cutout.

In some examples of the flow cell, the package further comprises: a cured electronic molded compound (EMC) material molded around portions of the die; a portion of the EMC material forming EMC material surfaces adjacent to the active surface on the at least two opposing sides of the active surface; and a portion of the EMC material surfaces comprise the fanout regions.

In some examples of the flow cell, the package comprises: a cured electronic molded compound (EMC) material molded around portions of the die; a layer deposited on the EMC material surfaces adjacent to the active surface on the at least two opposing sides of the active surface, where the fanout regions comprise portions of the layer.

In some examples of the flow cell, the package further comprises vias embedded in the EMC material.

In some examples of the flow cell, the one or more support pieces comprise a material selected from the group consisting of: glass, silicon, and ceramic.

In some examples of the flow cell, the substrate further comprises electrical contacts on a bottom surface of the substrate and the electrical contacts on a bottom surface of the substrate are electrically coupled to the electrical contacts on the top surface of the substrate by vias formed through the substrate.

In some examples of the flow cell, the substrate further comprises a heating element.

In some examples of the flow cell, the heating element comprises: one or more resistors on one or more of the top surface of the substrate and the bottom surface of the substrate; a metal plane in the substrate; and vias through the substrate coupling the one or more resistors to the metal plane in the substrate.

In some examples of the flow cell, the heating element comprising: a long wound metal trace in the substrate to function as a resistive heater.

In some examples of the flow cell, the lid comprises two apertures and each aperture defines one of an inlet or an outlet fluidic port.

In some examples of the flow cell, the top surface of the die comprises nanowells.

In some examples of the flow cell, the substrate is a printed circuit board.

In some examples of the flow cell, the substrate comprises a material selected from the group consisting of: a glass-reinforced epoxy laminate material, FR4, and co-fired ceramic sheets.

In some examples of the flow cell, the die is a complementary metal-oxide-semiconductor.

In some examples of the method disclosed herein, the method may include applying a first adhesive to a substrate, where a top surface of the substrate comprises electrical contacts. The method may also include orienting a die on the first adhesive, where a top surface of the die comprises an active surface and electrical contact points. The method may also include forming fanout regions for utilization in a fluidic path of the flow cell, where the forming the fanout regions comprises orienting one or more support pieces on the first adhesive adjacent to at least two sides of the die, where a portion of a top surface of the support pieces on the at least two sides of the die comprise the fanout regions. The method may further include connecting the electrical contacts on the top surface of the substrate to electrical contact points on the die. The method may also include applying a second adhesive to a portion of the one or more support pieces. The method may also include attaching a lid to the second adhesive, where the attaching defines a fluidic flow-cell cavity below the lid and above a surface comprising the active surface and the fanout regions.

In some examples of the methods disclosed herein, the one or more support pieces comprise two support pieces, and orienting the one or more support pieces on the first adhesive adjacent to the at least two sides of the die comprises placing two support pieces adjacent on opposing sides of the die.

In some examples of the methods disclosed herein, the one or more support pieces comprise one support piece, the one support piece comprises a cutout, and orienting the one or more support pieces on the first adhesive adjacent to the at least two sides of the die comprises orienting the one support piece such that the die and electrical contacts are within the cutout.

In some examples of the methods disclosed herein, the method also includes securing the wire-bonded connections with an epoxy.

In some examples of the methods disclosed herein, forming the heating element comprises: implementing a long wound metal trace in the substrate to function as a resistive heater.

In some examples of the methods disclosed herein, the method also includes utilizing the heating element to heat the substrate.

In some examples of the flow cells disclosed herein, a flow cell includes: a substrate comprising electrical contacts on a top surface, where the electrical contacts on the top surface of the substrate are connected to electrical contact points on a top surface of a die; a first cured adhesive, where the first cured adhesive joins the die and one or more support pieces adjacent to at least two sides of the die, to the substrate, where a portion of the top surface of the die and a portion of a top surface of the one or more support pieces, form a surface that is utilized in a fluidic path of the flow cell; a second cured adhesive, where the second cured adhesive joins areas of the one or more support pieces and areas of the top surface of the die proximate to the surface that is utilized in the fluidic path of the flow cell, to a lid; and the lid, where the lid defines a fluidic flow-cell cavity above the surface that is utilized in the fluidic path of the flow cell and below the lid.

In some examples of the flow cells disclosed herein, the one or more support pieces comprise two support pieces oriented on opposing sides of the die.

In some examples of the flow cells disclosed herein, the lid comprises two apertures and each aperture defines one of an inlet or an outlet fluidic port

In some examples of the methods disclosed herein, the method of forming a flow cell includes applying a first adhesive to a substrate, where a top surface of the substrate comprises electrical contacts. The method may also include orienting a die on the first adhesive, where a top surface of the die comprises an active surface and electrical contact points. The method may also include forming fanout regions for utilization in a fluidic path of the flow cell, where the forming of the fanout regions comprises: orienting two support pieces on the first adhesive on opposing sides of the die, each of the two support pieces adjacent to the die, where the top surface of the die and top surfaces of the two support pieces form an upper surface; and dispensing a material to fill gaps between the two support pieces and the die. The method may also include connecting the electrical contacts on the top surface of the substrate to electrical contact points on the die. The method may also include applying a second adhesive to a portion of the one or more support pieces and a portion of the die. The method may also include attaching a lid to the second adhesive, where the attaching defines a fluidic flow-cell cavity below the lid and above the upper surface.

In some examples of the methods disclosed herein, the method of forming a flow cell includes applying a first adhesive to a substrate, where a top surface of the substrate comprises electrical contacts. The method may also include orienting a die on the first adhesive, where a top surface of the die comprises an active surface and electrical contact points. The method may also include forming fanout regions for utilization in a fluidic path of the flow cell, where the forming the fanout regions comprises: orienting a support piece on the first adhesive, where the support piece comprises a cutout, and where the orienting comprises placing the support piece on the first adhesive such that the die and electrical contacts are positioned within the cutout, where the fanout regions comprise portions of a top surface of the support piece on opposing sides of the die, and where the portions of the top surface and the active surface form an upper surface. The method also includes connecting the electrical contacts on the top surface of the substrate to electrical contact points on the die with bond wires. The method also includes dispensing a second adhesive into the cutout such that the second adhesive fills spaces in the cutout between the die and the support piece and encapsulates the bond wires. The method also includes applying a third adhesive to a portion of the support piece and a portion of the die. The method also includes attaching a lid to the third adhesive, where the attaching defines a fluidic flow-cell cavity below the lid and above the upper surface.

In some examples of the methods disclosed herein, a method of forming a flow cell includes applying a first adhesive to a substrate, where a top surface of the substrate comprises electrical contacts. The method may also include orienting a package comprising a cured electronic molded compound (EMC) material molded around portions of a die, where a top surface of the die comprises an active surface and electrical contact points, and a portion of the EMC material forms EMC material surfaces adjacent to the active surface on at least two opposing sides of the active surface. The method may also include connecting the electrical contacts on the top surface of the substrate to electrical contact points on the die. The method may also include applying a second adhesive to a portion of a top surface of the package; and attaching a lid to the second adhesive, where the attaching defines a fluidic flow-cell cavity below the lid and above a surface comprising the active surface and fanout regions for utilization in a fluidic path of the flow cell, the fanout regions comprising another portion of the top surface of the package.

In some examples of the methods disclosed herein, the fanout regions are comprised of the EMC material surfaces adjacent to the active surface on the at least two opposing sides of the active surface.

In some examples of the methods disclosed herein, the package further comprises a layer deposited on the EMC material surfaces adjacent to the active surface on the at least two opposing sides of the active surface, and the fanout regions comprise portions of the layer deposited on the EMC material surfaces adjacent to the active surface on the at least two opposing sides of the active surface.

In some examples of the methods disclosed herein, connecting the electrical contacts on the top surface of the substrate to the electrical contact points on the die comprises wire-bonding the electrical contacts to the electrical contact points.

In some examples of the methods disclosed herein, the method includes securing the wire-bonded connections with an epoxy.

In some examples of the methods disclosed herein, the substrate further comprises electrical contacts on a bottom surface of the substrate, and the electrical contacts on a bottom surface of the substrate are electrically coupled to the electrical contacts on the top surface of the substrate by vias formed through the substrate.

In some examples of the methods disclosed herein, the package further comprises vias embedded in the EMC material.

In some examples of the flow cells disclosed herein, a flow cell includes: a substrate comprising electrical contacts on a top surface, where the electrical contacts on the top surface of the substrate are connected to electrical contact points on a top surface of a die. The flow cell may also include a first cured adhesive, where the first cured adhesive joins a package comprising a cured electronic molded compound (EMC) material molded around portions of a die, where a top surface of the die is exposed and comprises an active surface and the electrical contact points, and a portion of the EMC material forms EMC material surfaces adjacent to the active surface on at least two opposing sides of the active surface, where a portion of the EMC material surfaces comprise fanout regions for utilization in a fluidic path. The flow cell may also include a second cured adhesive, where the second cured adhesive joins a portion of a top surface of the package to a lid defining a fluidic flow-cell cavity below the lid and above a surface comprising the active surface and the fanout regions. The flow cell may also include the lid.

In some examples of the flow cells disclosed herein, the top surface of the die comprises nanowells.

In some examples of the flow cells disclosed herein, the substrate is a printed circuit board, and the die is a complementary metal-oxide-semiconductor.

In some examples of the flow cells disclosed herein, the substrate further comprises electrical contacts on a bottom surface of the substrate, and the electrical contacts on a bottom surface of the substrate are electrically coupled to the electrical contacts on the top surface of the substrate by vias formed through the substrate.

In some examples of the flow cells disclosed herein, a flow cell includes: a substrate comprising electrical contacts on a top surface, where the electrical contacts on the top surface of the substrate are connected to electrical contact points on a top surface of a die. The flow cell may include a first cured adhesive, where the first cured adhesive joins a package comprising a cured electronic molded compound (EMC) material molded around portions of the die, where a top surface of the die is exposed and comprises an active surface and the electrical contact points, and a portion of the EMC material forms EMC material surfaces adjacent to the active surface on at least two opposing sides of the active surface, where a layer is planarizing the EMC material surfaces, where a portion of the EMC material surfaces planarized by the layer comprise fanout regions for utilization in a fluidic path. The flow cell may include a second cured adhesive, where the second cured adhesive joins a portion of a top surface of the package to a lid defining a fluidic flow-cell cavity below the lid and above a surface comprising the active surface and the fanout regions. The flow cell may include the lid.

In some examples of methods for forming an elements of for possible utilization in one or more flow cells described herein, a method includes assembling a package comprising cured molded material surrounding portions of a one or more dies, where one or more pillars of a first electrically conductive material are embedded in the molded material, the assembling comprising: applying a temporary adhesive to a surface of a carrier. The method may also include orienting the one or more pillars on the adhesive. The method may also include orienting the one or more dies on the adhesive such that one or more pillars are oriented between each die of the one or more dies, where each one or more pillars is of a greater vertical length than each of the one or more dies. The method may also include molding the material on the top surface of the carrier and around some surfaces of the one or more dies and the one or more pillars such that a top surface of the mold is of a greater vertical length that the one or more pillars, where the top surface of the mold is parallel to the surface of the carrier. The method may also include curing the molded material. The method may also include grinding the top surface of the mold to expose top surfaces of the one or more pillars and top surfaces of the one or more dies to create a new surface. The method may also include plating the top surfaces of the one or more pillars with a second electrically conductive material to create a seed layer. The method may also include applying one or more redistribution layers (RDLs), where applying each RDL comprises: patterning the layer above the new surface. The method may also include opening portions of the layer to form openings. The method may also include spreading a third electrically conductive material into each opening such that the third electrically conductive material is spread through the openings and electrically coupled to the seed layer. The method may also include attaching electrical contacts to a portion of the third electrically conductive material in the openings of an RDL of the one or more RDLs. The method may also include removing the carrier and the temporary adhesive to expose a package surface.

In some examples of the methods disclosed herein, the method includes: applying surface chemistry to surfaces of the one or more dies exposed by removing the carrier and the temporary adhesive to create active surfaces; and plating surfaces of the one or more pillars exposed by removing the carrier and the temporary adhesive to create electrical contacts on the pillars.

In some examples of the methods disclosed herein, the method includes: electrically coupling the electrical contacts on the pillars to portions of the surfaces of the one or more dies comprising the chemistry.

In some examples of the methods disclosed herein, a method of electrically coupling the electrical contacts on the pillars to portions of the surfaces of the one or more dies comprising the chemistry is selected from the group consisting of: wire-bonding and printing.

In some examples of the methods disclosed herein, the method includes: attaching one or more lids to the package surface, where a fluidic flow-cell cavity is defined below each of the one or more lids and above a surface of each of the corresponding one or more sensors comprising the active surface.

In some examples of the methods disclosed herein, the first electrically conductive material and the third electrically conductive material are copper.

In some examples of the methods disclosed herein, the second electrically conductive material comprises one or more of nickel and gold.

In some examples of the methods disclosed herein, attaching the one or more lids comprises applying an adhesive to a portion of the package surface.

In some examples of the methods disclosed herein, opening the portions of the layer to form openings comprises utilizing photolithography.

In some examples of the methods disclosed herein, the one or more RDLs comprise three RDLs.

In some examples of the methods disclosed herein, orienting the one or more pillars and orienting the one or more dies comprise utilizing a pick and place tool.

In some examples of the methods disclosed herein, the molded material comprises electronic molded compound (EMC) material.

In some examples of the flow cells disclosed herein, a flow cell includes: a package comprising cured material molded around portions of a die, where one or more pillars of a first electrically conductive material are embedded in the molded material, where a top surface of the package comprises an active surface of the die. The flow cell may also include a lid attached to portion of the top surface of the package, where a fluidic flow-cell cavity is defined below the lid and above the active surface.

In some examples of the flow cells disclosed herein, the package includes one or more redistribution layers (RDLs), attached to a bottom surface of the package. The RDLs comprise openings filled with electrically conductive material electrically coupled to the at least one of the one or more pillars.

In some examples of the flow cells disclosed herein, the package includes electrical contacts electrically coupled to the electrically conductive material in the openings of the one or more RDLs.

In some examples of the flow cells disclosed herein, the cured material comprises electronic molded compound (EMC).

The flowchart and block diagrams in the figures illustrate the architecture, functionality, and operation of possible implementations of systems, methods, and computer program products according to various examples of the present implementation. In this regard, each block in the flowchart or block diagrams can represent a module, segment, or portion of instructions, which comprises one or more executable instructions for implementing the specified logical function(s). In some alternative implementations, the functions noted in the blocks can occur out of the order noted in the Figures. For example, two blocks shown in succession can, in fact, be executed substantially concurrently, or the blocks can sometimes be executed in the reverse order, depending upon the functionality involved. It will also be noted that each block of the block diagrams and/or flowchart illustration, and combinations of blocks in the block diagrams and/or flowchart illustration, can be implemented by special purpose hardware-based systems that perform the specified functions or acts or carry out combinations of special purpose hardware and computer instructions.

The terminology used herein is for the purpose of describing particular examples only and is not intended to be limiting. As used herein, the singular forms “a”, “an” and “the” are intended to include the plural forms as well, unless the context clearly indicates otherwise. It will be further understood that the terms “comprises” and/or “comprising”, when used in this specification, specify the presence of stated features, integers, steps, processes, operations, elements, and/or components, but do not preclude the presence or addition of one or more other features, integers, steps, processes, operations, elements, components and/or groups thereof.

The corresponding structures, materials, acts, and equivalents of all means or step plus function elements in the claims below, if any, are intended to include any structure, material, or act for performing the function in combination with other claimed elements as specifically claimed. The description of one or more examples has been presented for purposes of illustration and description but is not intended to be exhaustive or limited to in the form disclosed. Many modifications and variations will be apparent to those of ordinary skill in the art. The example was chosen and described in order to best explain various aspects and the practical application, and to enable others of ordinary skill in the art to understand various examples with various modifications as are suited to the particular use contemplated.

It should be appreciated that all combinations of the foregoing concepts and additional concepts discussed in greater detail below (provided such concepts are not mutually inconsistent) are contemplated as being part of the subject matter disclosed herein at least to achieve the benefits as described herein. In particular, all combinations of claims subject matter appearing at the end of this disclosure are contemplated as being part of the subject matter disclosed herein. It should also be appreciated that terminology explicitly employed herein that also may appear in any disclosure incorporated by reference should be accorded a meaning most consistent with the particular concepts disclosed herein.

This written description uses examples to disclose the subject matter, and also to enable any person skilled in the art to practice the subject matter, including making and using any devices or systems and performing any incorporated methods. The patentable scope of the subject matter is defined by the claims, and may include other examples that occur to those skilled in the art. Such other examples are intended to be within the scope of the claims if they have structural elements that do not differ from the literal language of the claims, or if they include equivalent structural elements with insubstantial differences from the literal languages of the claims.

It is to be understood that the above description is intended to be illustrative, and not restrictive. For example, the above-described examples (and/or aspects thereof) may be used in combination with each other. In addition, many modifications may be made to adapt a particular situation or material to the teachings of the various examples without departing from their scope. While the dimensions and types of materials described herein are intended to define the parameters of the various examples, they are by no means limiting and are merely provided by way of example. Many other examples will be apparent to those of skill in the art upon reviewing the above description. The scope of the various examples should, therefore, be determined with reference to the appended claims, along with the full scope of equivalents to which such claims are entitled. In the appended claims, the terms “including” and “in which” are used as the plain-English equivalents of the respective terms “comprising” and “wherein.” Moreover, in the following claims, the terms “first,” “second,” and “third,” etc. are used merely as labels, and are not intended to impose numerical requirements on their objects. Forms of term “based on” herein encompass relationships where an element is partially based on as well as relationships where an element is entirely based on. Forms of the term “defined” encompass relationships where an element is partially defined as well as relationships where an element is entirely defined. Further, the limitations of the following claims are not written in means-plus-function format and are not intended to be interpreted based on 35 U.S.C. § 112, sixth paragraph, unless and until such claim limitations expressly use the phrase “means for” followed by a statement of function void of further structure. It is to be understood that not necessarily all such objects or advantages described above may be achieved in accordance with any particular example. Thus, for example, those skilled in the art will recognize that the systems and techniques described herein may be embodied or carried out in a manner that achieves or optimizes one advantage or group of advantages as taught herein without necessarily achieving other objects or advantages as may be taught or suggested herein.

While the subject matter has been described in detail in connection with only a limited number of examples, it should be readily understood that the subject matter is not limited to such disclosed examples. Rather, the subject matter can be modified to incorporate any number of variations, alterations, substitutions or equivalent arrangements not heretofore described, but which are commensurate with the spirit and scope of the subject matter. Additionally, while various examples of the subject matter have been described, it is to be understood that aspects of the disclosure may include only some of the described examples. Also, while some examples are described as having a certain number of elements it will be understood that the subject matter can be practiced with less than or greater than the certain number of elements. Accordingly, the subject matter is not to be seen as limited by the foregoing description but is only limited by the scope of the appended claims.

1. A method of forming a flow cell, comprising:
applying a first adhesive to a substrate, wherein a top surface of the substrate comprises electrical contacts;
orienting a package on the first adhesive, the package comprising a die wherein a top surface of the die comprises an active surface and electrical contact points and surfaces adjacent to the active surface on at least two opposing sides of the active surface form fanout regions for utilization in a fluidic path of the flow cell;
connecting the electrical contacts on the top surface of the substrate to electrical contact points on the die;
applying a second adhesive to a part of the package; and
attaching a lid to the second adhesive, wherein the attaching defines a fluidic flow-cell cavity below the lid and above a surface comprising the active surface and the fanout regions.

2. The method of claim 1, further comprising:
forming the package, the forming the package comprising:
orienting the die on the first adhesive; and
forming the fanout regions by orienting one or more support pieces on the first adhesive adjacent to at least two sides of the die, wherein the fanout regions comprise a portion of a top surface of the support pieces.

3. The method of claim 2, wherein the one or more support pieces comprise two support pieces, and wherein the orienting the one or more support pieces on the first adhesive adjacent to the at least two sides of the die comprises placing two support pieces adjacent to the die on opposing sides of the die.

4. The method of claim 2, wherein the one or more support pieces comprise one support piece, wherein the one support piece comprises a cutout, and wherein the orienting the one or more support pieces on the first adhesive adjacent to the at least two sides of the die comprises orienting the one support piece such that the die and electrical contacts are within the cutout.

5. The method of claim 1, wherein the package comprises a cured electronic molded compound (EMC) material molded around portions of the die, wherein a portion of the EMC material comprises the fanout regions.

6. A flow cell, comprising:
a substrate comprising electrical contacts on a top surface, wherein the electrical contacts on the top surface of the substrate are connected to electrical contact points on a top surface of a die;
a first cured adhesive, wherein the first cured adhesive is joined to a package, the package comprising:
the die, wherein the top surface of the die further comprises an active surface; and
fanout regions comprising surfaces adjacent at least two opposing sides of the active surface, the fanout regions at least partially defining a fluidic path of the flow cell;
a second cured adhesive, wherein the second cured adhesive joins a portion of a top surface of the package to a lid defining a fluidic flow-cell cavity below the lid and above a surface comprising the active surface and the fanout regions; and
the lid.

7. The flow cell of claim 6, wherein the package further comprises:
one or more support pieces adjacent to the at least two opposing sides of the active surface of the die, wherein the one or more support pieces comprise the fanout regions.

8. The flow cell of claim 7, wherein the one or more support pieces comprise two support pieces oriented on the at least two opposing sides of the active surface of the die.

9. The flow cell of claim 7, wherein the one or more support pieces comprise one support piece, wherein the one support piece comprises a cutout, wherein the die and the electrical contacts on the top surface of the substrate are oriented within the cutout.

10. The flow cell of claim 6, wherein the package further comprises:
a cured electronic molded compound (EMC) material molded around portions of the die;
a portion of the EMC material forming EMC material surfaces adjacent to the active surface on the at least two opposing sides of the active surface; and
a portion of the EMC material surfaces comprise the fanout regions.

11-37. (canceled)

38. The flow cell of claim 6, wherein the package comprises:
a cured electronic molded compound (EMC) material molded around portions of the die;
a layer deposited on the EMC material surfaces adjacent to the active surface on the at least two opposing sides of the active surface, wherein the fanout regions comprise portions of the layer.

39. The flow cell of claim 10, wherein the package further comprises vias embedded in the EMC material.

40. (canceled)

41. The flow cell of claim 6, wherein the substrate further comprises electrical contacts on a bottom surface of the substrate, wherein the electrical contacts on a bottom surface of the substrate are electrically coupled to the electrical contacts on the top surface of the substrate by vias formed through the substrate.

42. The flow cell of claim 6, the substrate further comprising a heating element.

43. The flow cell of claim 42, the heating element comprising:
one or more resistors on one or more of the top surface of the substrate and the bottom surface of the substrate;
a metal plane in the substrate; and
vias through the substrate coupling the one or more resistors to the metal plane in the substrate.

44. The flow cell of claim 42, the heating element comprising: a long wound metal trace in the substrate to function as a resistive heater.

45. The flow cell of claim 6, wherein the lid comprises two apertures and each aperture defines one of an inlet or an outlet fluidic port.

46. The flow cell of claim 6, wherein the top surface of the die comprises nanowells.

47. (canceled)

48. The flow cell of claim 6, wherein the substrate comprises a material selected from the group consisting of: a glass-reinforced epoxy laminate material, FR4, and co-fired ceramic sheets.

49. The flow cell of claim 6, wherein the die is a complementary metal-oxide-semiconductor.

50-132. (canceled)
